(19) United States
(12) Patent Application Publication
(10) Pub. No.: US 2025/0343631 A1
(43) Pub. Date: Nov. 6, 2025

(54) ARTIFICIAL INTELLIGENCE-ENABLED RETRANSMISSIONS

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US); Vishal DALMIYA, San Diego, CA (US); Siddhant MEHROTRA, CARLSBAD, CA (US)

(21) Appl. No.: 18/655,021

(22) Filed: May 3, 2024

(51) Int. Cl. H04L 1/1812; H04W 8/22; H04W 28/06; H04W 76/20

(52) U.S. Cl. CPC H04L 1/1812; H04W 8/22; H04W 28/06; H04W 76/20

(57) ABSTRACT

Methods, systems, and devices for wireless communication are described. A device may receive control signaling that indicates a configuration that includes a first set of one or more parameters for hybrid automatic repeat request (HARQ) associated with a radio link control (RLC) entity of the device. The device may receive at least one HARQ feedback for at least one protocol data unit (PDU) of a set of one or more PDUs associated with the RLC entity of the device. The device may perform one or more operations based on the at least one HARQ feedback and in accordance with the first set of one or more parameters for HARQ, wherein the one or more operations include a discard of the at least one PDU or a retransmission of the at least one PDU.

### INTRODUCTION

The following relates to wireless communication, including managing wireless communication (e.g., transmission, retransmissions, reception).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless device is described. The method may include receiving control signaling that indicates a configuration including a first set of one or more parameters for hybrid automatic repeat request (HARQ) associated with a radio link control (RLC) entity of the wireless device, receiving at least one HARQ feedback for at least one protocol data unit (PDU) of a set of one or more PDUs associated with the RLC entity of the wireless device, and perform one or more operations based on the at least one HARQ feedback and in accordance with the first set of one or more parameters for HARQ, where the one or more operations include a discard of the at least one PDU or a retransmission of the at least one PDU.

A wireless device for wireless communications is described. The wireless device may include one or more memories storing processor executable code, and one or more processors coupled with the one or more memories. The one or more processors may individually or collectively be operable to execute the code to cause the wireless device to receive control signaling that indicates a configuration including a first set of one or more parameters for HARQ associated with a RLC entity of the wireless device, receive at least one HARQ feedback for at least one PDU of a set of one or more PDUs associated with the RLC entity of the wireless device, and perform one or more operations based on the at least one HARQ feedback and in accordance with the first set of one or more parameters for HARQ, where the one or more operations include a discard of the at least one PDU or a retransmission of the at least one PDU.

Another wireless device for wireless communications is described. The wireless device may include means for receiving control signaling that indicates a configuration including a first set of one or more parameters for HARQ associated with a RLC entity of the wireless device, means for receiving at least one HARQ feedback for at least one PDU of a set of one or more PDUs associated with the RLC entity of the wireless device, and means for perform one or more operations based on the at least one HARQ feedback and in accordance with the first set of one or more parameters for HARQ, where the one or more operations include a discard of the at least one PDU or a retransmission of the at least one PDU.

A non-transitory computer-readable medium storing code for wireless communications is described. The code may include instructions executable by one or more processors to receive control signaling that indicates a configuration including a first set of one or more parameters for HARQ associated with a RLC entity of the wireless device, receive at least one HARQ feedback for at least one PDU of a set of one or more PDUs associated with the RLC entity of the wireless device, and perform one or more operations based on the at least one HARQ feedback and in accordance with the first set of one or more parameters for HARQ, where the one or more operations include a discard of the at least one PDU or a retransmission of the at least one PDU.

In some examples of the method, wireless devices, and non-transitory computer-readable medium described herein, the first set of one or more parameters includes an input to a model for the HARQ associated with the RLC entity of the wireless device, a second set of one or more parameters includes an output of the model, and the one or more operations may be performed further based on the output of the model.

Some examples of the method, wireless devices, and non-transitory computer-readable medium described herein may further include operations, features, means, or instructions for retransmitting the at least one PDU based on the at least one HARQ feedback and in accordance with the first set of one or more parameters and where the at least one PDU includes one or more of a RLC service data unit (SDU), a RLC PDU, or a medium access control (MAC) PDU.

In some examples of the method, wireless devices, and non-transitory computer-readable medium described herein, a RLC header of the at least one PDU indicates a retransmission of one or more of the RLC SDU or the RLC PDU.

In some examples of the method, wireless devices, and non-transitory computer-readable medium described herein, a MAC header of a medium access control-control element (MAC-CE) indicates a retransmission of the MAC PDU and an uplink control information (UCI) indicates the retransmission of the at least one PDU.

In some examples of the method, wireless devices, and non-transitory computer-readable medium described herein, an UCI header or UCI indicates a retransmission of the at least one PDU.

Some examples of the method, wireless devices, and non-transitory computer-readable medium described herein may further include operations, features, means, or instructions for selecting a redundancy version of a set of redundancy versions for the retransmission of the at least one PDU and retransmitting the at least one PDU based on the redundancy version.

Some examples of the method, wireless devices, and non-transitory computer-readable medium described herein may further include operations, features, means, or instructions for obtaining a second set of one or more parameters for HARQ associated with the RLC entity of the wireless device and where the one or more operations may be performed further based on the second set of one or more parameters.

In some examples of the method, wireless devices, and non-transitory computer-readable medium described herein, at least one parameter of the second set of one or more parameters includes a packet delay budget and the one or more operations may be performed further based on that the packet delay budget satisfies or predicted to satisfy a threshold value.

Some examples of the method, wireless devices, and non-transitory computer-readable medium described herein may further include operations, features, means, or instructions for generate a report associated with a model for the HARQ associated with the RLC entity of the wireless device, where the report includes a set of one or more logs associated with processing of one or more PDUs of the set of one or more PDUs in accordance with the model and transmit, to a network entity, the report associated with the model.

In some examples of the method, wireless devices, and non-transitory computer-readable medium described herein, at least one log of the set of one or more logs indicates one or more of the first set of one or more parameters for HARQ associated with the RLC entity of the wireless device, a second set of one or more parameters for HARQ associated with the RLC entity of the wireless device, timing information associated with one or more dropped PDUs of the set of one or more PDUs or one or more retransmitted PDUs of the set of one or more PDUs, or a set of one or more sequence numbers associated with the one or more dropped PDUs of the set of one or more PDUs or one or more retransmitted PDUs of the set of one or more PDUs.

Some examples of the method, wireless devices, and non-transitory computer-readable medium described herein may further include operations, features, means, or instructions for determining a set of one or more performance metrics associated with a model for HARQ associated with a RLC entity of the wireless device based on the one or more operations performed, where the set of one or more performance metrics may be based on a set of one or more HARQ events associated with the set of one or more PDUs, receiving, from a network entity, a status control PDU that includes a report that indicates a set of one or more errors associated with the model for HARQ, where the report indicates one or more of a quantity of duplicate sequence numbers of RLC PDU or a quantity of duplicate PDUs, and determining a prediction error based on one or more of the set of one or more performance metrics or the reported set of one or more errors associated with the model for HARQ by the network entity.

Some examples of the method, wireless devices, and non-transitory computer-readable medium described herein may further include operations, features, means, or instructions for transmit, to a network entity, a report including capability information that indicates whether the wireless device supports a model for HARQ associated with the RLC entity of the wireless device, where the capability information may be based on a performance metric associated with the model and where the control signaling may be received based on the capability information that indicates whether the wireless device supports the model.

In some examples of the method, wireless devices, and non-transitory computer-readable medium described herein, the first set of one or more parameters may include operations, features, means, or instructions for at least one first parameter that indicates a first threshold quantity of HARQ retransmissions, where the first threshold quantity of retransmissions may be to be satisfied before an early retransmission of the at least one PDU, at least one second parameter that indicates a second threshold quantity of HARQ retransmissions, where the second threshold quantity of retransmissions may be to be satisfied before the early retransmission of the at least one PDU and in response to an absence of the at least one HARQ feedback for the at least one PDU, at least one third parameter that indicates a first threshold duration, where the first threshold duration may be to be satisfied after a first HARQ retransmission before the early retransmission of the at least one PDU, at least one fourth parameter that indicates a second threshold duration, where the second threshold duration may be to be satisfied after the first HARQ retransmission before the early retransmission of the at least one PDU and in response to the absence of the at least one HARQ feedback for the at least one PDU, at least one fifth parameter that indicates a set of one or more carriers that support the early retransmission of the at least one PDU, at least one sixth parameter that enables padding, where the at least one PDU of the early retransmission of the at least one PDU may be padded, at least one seventh parameter that indicates a threshold quantity of retransmissions of the set of one or more PDUs within a time window, at least one eighth parameter that indicates the time window, at least one ninth parameter that indicates whether a model for HARQ may be enabled or disabled, and at least one tenth parameter that indicates a traffic flow identifier for early retransmission of one or more PDUs of the set of one or more PDUs.

In some examples of the method, wireless devices, and non-transitory computer-readable medium described herein, the second set of one or more parameters may include operations, features, means, or instructions for at least one first parameter that indicates a threshold quantity of retransmissions for the set of one or more PDUs, at least one second parameter that indicates a retransmission window associated with the threshold quantity of retransmissions for the set of one or more PDUs, at least one third parameter that indicates a latency to tune a model for HARQ associated with the RLC entity of the wireless device, at least one fourth parameter that indicates whether discarding of one or more PDUs of the set of one or more PDUs may be allowed in accordance with the model for HARQ associated with the RLC entity of the wireless device, at least one fifth parameter that indicates a threshold quantity of discards for the set of one or more PDUs, and at least one sixth parameter that indicates a discard window associated with the threshold quantity of discards for the set of one or more PDUs.

Some examples of the method, wireless devices, and non-transitory computer-readable medium described herein may further include operations, features, means, or instructions for disabling a model for the HARQ associated with the RLC entity of the wireless device based on at least one parameter of a second set of one or more parameters and where the one or more operations may be performed further based on the disabled model.

Some examples of the method, wireless devices, and non-transitory computer-readable medium described herein may further include operations, features, means, or instructions for transmitting, to a network entity, an indication of the disabled model and the at least one parameter of the second set of one or more parameters, where the at least one parameter may be to be satisfied before disabling the model.

In some examples of the method, wireless devices, and non-transitory computer-readable medium described herein, the one or more operations may be performed irrespective of the disabled model.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports AI-enabled retransmissions in accordance with one or more aspects of the present disclosure.

FIG. 2 shows an example of a network architecture that supports AI-enabled retransmissions in accordance with one or more aspects of the present disclosure.

FIG. 3 shows a block diagram of a UE that supports AI-enabled retransmissions in accordance with one or more aspects of the present disclosure.

FIGS. 4 through 10 show examples of process flows that support AI-enabled retransmissions in accordance with one or more aspects of the present disclosure.

FIG. 11 shows an example of a wireless communications system that supports AI-enabled retransmissions in accordance with one or more aspects of the present disclosure.

FIG. 12 shows an example of a process flow that supports AI-enabled retransmissions in accordance with one or more aspects of the present disclosure.

FIGS. 13 and 14 show block diagrams of devices that support AI-enabled retransmissions in accordance with one or more aspects of the present disclosure.

FIG. 15 shows a block diagram of a communications manager that supports AI-enabled retransmissions in accordance with one or more aspects of the present disclosure.

FIG. 16 shows a diagram of a system including a device that supports AI-enabled retransmissions in accordance with one or more aspects of the present disclosure.

FIG. 17 shows a flowchart illustrating methods that support AI-enabled retransmissions in accordance with one or more aspects of the present disclosure.

### DETAILED DESCRIPTION

A wireless device may be equipped with a protocol stack to support various functionalities associated with wireless communication. The protocol stack may include various protocol layers. One example of a protocol layer includes an RLC layer (also referred to as an RLC entity herein). The RLC layer may perform the transfer of upper layer protocol data units (PDUs) according to one or more modes, including: an acknowledged mode (AM), an unacknowledged mode (UM), and a transparent mode (TM). The RLC layer may be referred to as a TM RLC entity, an UM RLC entity, or an AM RLC entity based on a configured mode of data transfer for the RLC entity. The RLC layer may receive an RLC service data unit (SDU) from and/or transmit to upper protocol layers of the protocol stack of the wireless device.

One or more protocol layers of the protocol stack of the wireless device may support hybrid automatic repeat request (HARQ) operations (e.g., HARQ feedback) to increase the likelihood of a successful transmission and/or reception of a set of one or more PDUs (e.g., RLC SDUs, RLC PDUs). For example, the RLC layer of the wireless device may support HARQ operations to increase the likelihood of a successful transmission and/or reception of the set of one or more PDUs. In some cases, the wireless device may detect a success or a failure of HARQ feedback based on a set of one or more HARQ events (e.g., acknowledgment (ACK)/negative ACK (NACKs)). After processing (e.g., analyzing) the set of one or more HARQ events, the wireless device may determine (e.g., predict) a success or a failure associated with a next HARQ feedback (i.e., a successful transmission and/or reception of a next PDU).

The RLC layer of the wireless device may support the retransmission of one or more PDUs from the set of one or more PDUs. In some cases, such retransmission by the RLC layer of the wireless device may result in high latency. Additionally, the wireless device may refrain from transmitting a subsequent PDU from the set of one or more PDUs until it receives HARQ feedback for the previously transmitted PDU from the set. Alternatively, the wireless device may be capable, configured, or operable to transmit multiple PDUs from the set, with each PDU of the transmitted multiple PDUs corresponding to a separate HARQ process (e.g., HARQ feedback). Consequently, each HARQ process may have one PDU pending an ACK or a NACK.

In some cases, the wireless device may be capable of, configured for, or operable to support asynchronous HARQ, allowing it to initiate a HARQ retransmission at any time. While asynchronous HARQ offers flexibility and responsiveness, such retransmissions may result in increased overhead and resource usage in some instances. For example, the wireless device may have to allocate memory (e.g., resources) for one or more PDUs from the set. When the wireless device detects HARQ failure with a high probability, the wireless device may be prohibited from performing retransmissions. This can lead to high latency, thereby straining the memory of the wireless device due to excessive buffer allocation for the set of PDUs awaiting ACK and/or NACK.

Various aspects of the present disclosure relate to enabling the wireless device to support retransmission or discard (e.g., drop) of one or more PDUs of the set of one or more PDUs in accordance with a model (e.g., an AI/ML model). As such, the wireless device may support AI-enabled retransmission and/or AI-enabled discard. The wireless device may additionally, or alternatively, manage a buffer (e.g., memory) of the wireless device in accordance with the model. For example, the wireless device may be capable of, configured to, or operable to support an AI/ML model to manage a buffer of the wireless device based on one or more HARQ events (e.g., ACK/NACKs). The wireless device may also support early retransmission of one or more PDUs of a set of one or more PDUs or discard of the one or more PDUs of the set of one or more PDUs. The wireless device may support the early retransmission or early discard in accordance with the model and based on one or more sets of one or more parameters as described herein. By enabling the wireless device to support AI-enabled retransmission and/or AI-enabled discard, the wireless device may experience reduced processing and reduced power consumption.

Aspects of the disclosure are initially described in the context of wireless communications systems. Aspects of the disclosure are further illustrated by and described with reference to apparatus diagrams, system diagrams, and flowcharts that relate to AI-enabled retransmissions.

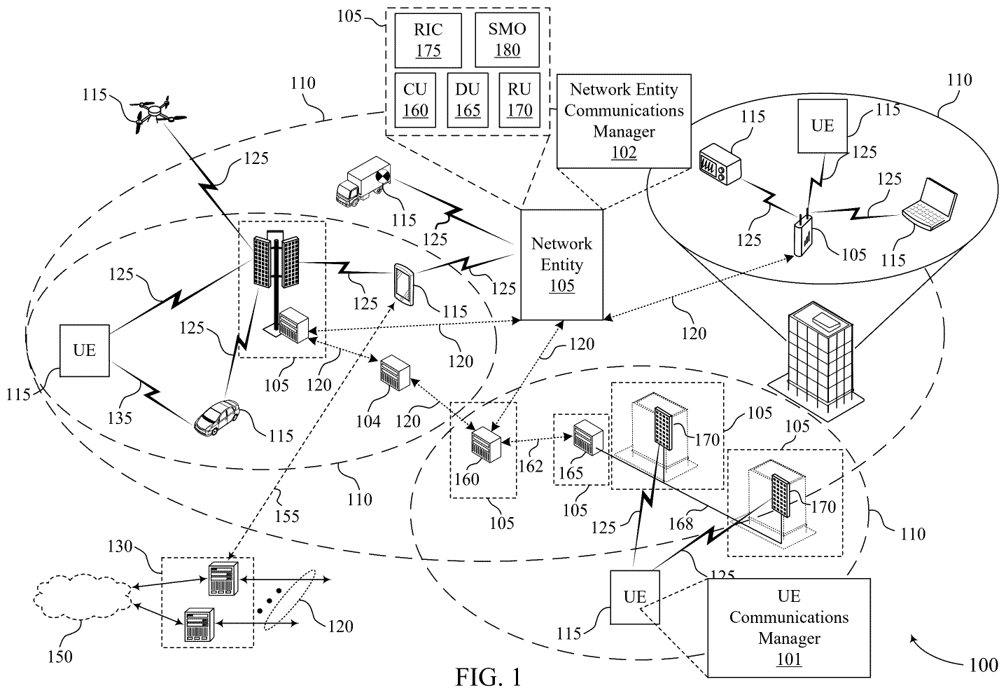

FIG. 1 shows an example of a wireless communications system 100 that supports AI-enabled retransmissions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein. The network entities 105 may include a network entity communications manager 102, which may be configured to support communications in the wireless communications system 100. Similarly, the UEs 115 may include a UE communications manager 101, which may be configured to support communications in the wireless communications system 100.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

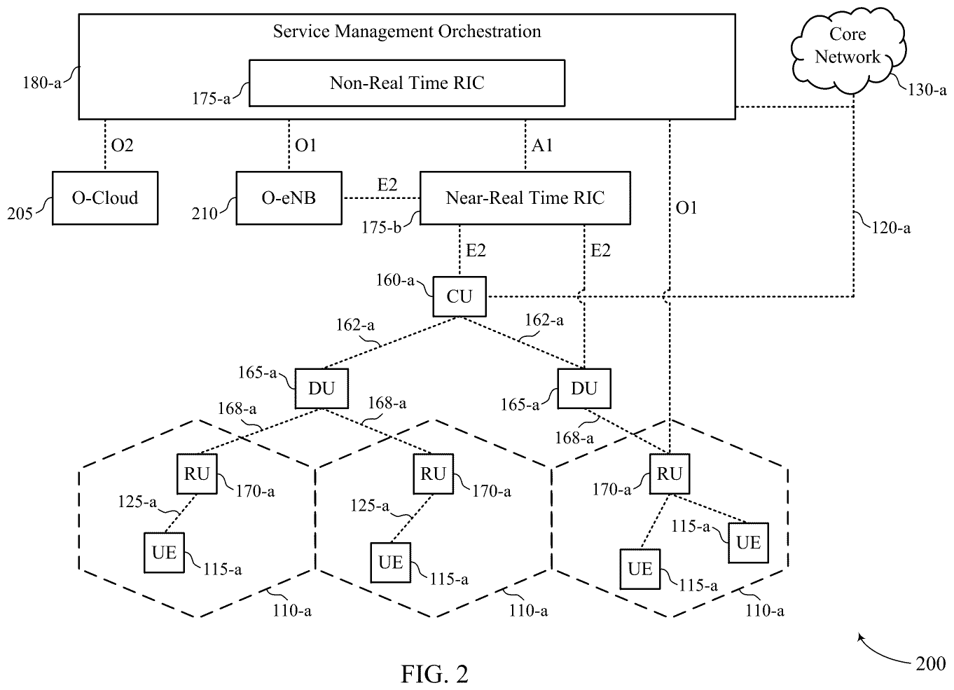

FIG. 2 shows an example of a network architecture 200 (e.g., a disaggregated base station architecture, a disaggregated RAN architecture) that supports AI-enabled retransmissions in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an 02 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

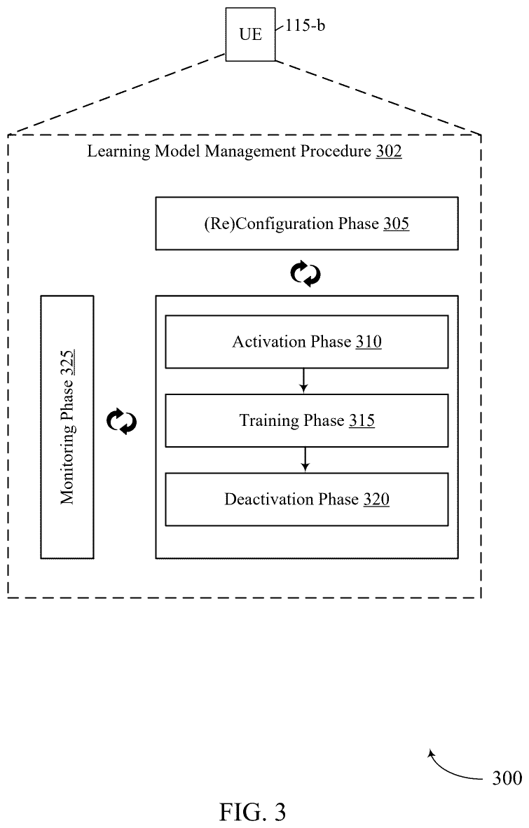

FIG. 3 shows an example of a block diagram 300 of a UE 115-b that supports AI-enabled retransmissions in accordance with one or more aspects of the present disclosure. The UE 115-b may be an example of aspects of a UE 115 as described herein with reference to FIGS. 1 and 2, respectively. The UE 115-b may implement aspects of the wireless communications system 100 as described with reference to FIG. 1. Additionally, or alternatively, the UE 115-b may implement or be implemented by aspects of the network architecture 200 as described herein with reference to FIG. 2.

In the example of FIG. 3, the UE 115-b may support a learning model management procedure 302 associated with one or more learning models for AI-enabled retransmission and/or AI-enabled discard. The learning model management procedure 302 may include one or more of a (re) configuration phase 305, an activation phase 310, a training phase 315 (also referred to as an inference phase), a deactivation phase 320, or a monitoring phase 325. The one or more learning models for AI-enabled retransmission and/or AI-enabled discard may be locally stored (e.g., one or more memories storing processor-executable code of the at least one learning model AI-enabled retransmission and/or AI-enabled discard) at the UE 115-b. Alternatively, the UE 115-b may obtain (e.g., download) the one or more learning models for AI-enabled retransmission and/or AI-enabled discard, for example, via a network entity 105 or a base station 140, which may be examples of network entities 105 or base stations 140 as described herein with reference to FIGS. 1 and 2, respectively.

One or more operations of the learning model management procedure 302 may be implemented by the UE 115-b or components (e.g., one or more memories storing processor-executable code, one or more processors coupled with the one or more memories and individually or collectively operable to execute the code to cause the UE 115-b to perform the operations associated with AI-enabled retransmission and/or AI-enabled discard) as described herein. In the following description of the learning model management procedure 302, the one or more operations performed by the UE 115-b may be performed in different orders or at different times. Some operations may also be omitted from the learning model management procedure 302, and other operations may be added to the learning model management procedure 302.

During the (re) configuration phase 305, the UE 115-b may receive, from a network entity 105 or a base station 140, a set of one or more configurations including a set of one or more parameters for configuring or reconfiguring one or more learning models (e.g., AI/ML models) for AI-enabled retransmission and/or AI-enabled discard. The UE 115-b may receive, from a network entity 105 or a base station 140, a request message for configuring or reconfiguring the one or more learning models for AI-enabled retransmission and/or AI-enabled discard. The request may include the set of one or more configurations and one or more identifiers associated with one or more learning models for AI-enabled retransmission and/or AI-enabled discard. The UE 115-b may transmit, to the network entity 105 or the base station 140, a response message that includes an acknowledgement of the request message.

In some examples, the set of one or more parameters may be for managing (e.g., training, updating, modifying) the one or more learning models. In some other examples, the set of one or more parameters may be an input for the one or more learning models, for example, for inference of the one or more learning models. In other examples, the set of one or more parameters may be for monitoring one or more performance metrics (also referred to as key performance indicators (KPIs)) for the one or more learning models. Additionally, or alternatively, the set of one or more configurations may include one or more RRC configurations (e.g., one or more measurement configurations, one or more MAC configurations, or the like).

During the activation phase 310, the UE 115-b may activate at least one learning model for AI-enabled retransmission and/or AI-enabled discard (e.g., for at least one action associated with AI-enabled retransmission and/or AI-enabled discard). During the training phase 315, the UE 115-b may train the at least one learning model for AI-enabled retransmission and/or AI-enabled discard to obtain a set of one or more outputs based at least in part on a set of one or more inputs (e.g., a set of one or more parameters). During the deactivation phase 320, the UE 115-b may deactivate the at least one learning model (e.g., for at least one action associated with AI-enabled retransmission and/or AI-enabled discard).

During the monitoring phase 325, the UE 115-b may monitor (e.g., track) a performance of the at least one learning model. One or more of a network entity 105, a base station 140, or the UE 115-b may share (e.g., transmit, receive, exchange) feedback associated with the performance of the at least one learning model for AI-enabled retransmission and/or AI-enabled discard. The performance may be associated with a system performance (e.g., spectral efficiency, power consumption, delay, etc.) or a model performance (e.g., prediction accuracy, resource usage, inference delay, etc.). In some examples, one or more of a network entity 105, a base station 140, or the UE 115-b may trigger a switching event that includes switching (e.g., changing) from at least one learning model to at least one different learning model, for example, based at least in part on feedback associated with a performance of the at least one learning model. In some other examples, one or more of a network entity 105, a base station 140, or the UE 115-b may update the training of the at least one learning model for AI-enabled retransmission and/or AI-enabled discard based at least in part on the feedback associated with the performance of the at least one learning model.

The UE 115-b may switch from at least one learning model to at least one different learning model based at least in part on a function supported by the different learning model (e.g., an action associated with AI-enabled retransmission and/or AI-enabled discard). In some examples, the UE 115-b may receive, from a network entity 105 or a base station 140, a request message to switch to the at least one different learning model. The request message may indicate an identifier associated with the at least one different learning model for AI-enabled retransmission and/or AI-enabled discard, and the UE 115-b may identify the least one different learning model based at least in part on the identifier. During the activation phase 310 of the learning model management procedure 302, the UE 115-b may activate the at least one different learning model (e.g., a different AI/ML model) for AI-enabled retransmission and/or AI-enabled discard. Additionally, during the deactivation phase 320, the UE 115-b may deactivate the at least one learning model (e.g., a current AI/ML model).

Additionally, or alternatively, during the monitoring phase 325, the UE 115-b may trigger the switching event based at least in part on a change in one or more parameters of the UE 115-b (e.g., a number of antennas, a number of carriers, etc.). In some examples, the UE 115-b may trigger the switching event based at least in part on a change in a location of the UE 115-b (e.g., a change from an indoor environment to an outdoor environment, or vice-versa). In some other examples, the UE 115-b may trigger the switching event based at least in part on a change in a service (e.g., network slice, QoS flow, session, etc.).

Accordingly, the UE 115-b may be configured to support managing (e.g., configuring, reconfiguring, activating, deactivating, monitoring, reporting, etc.) of one or more leaning models for AI-enabled retransmission and/or AI-enabled discard.

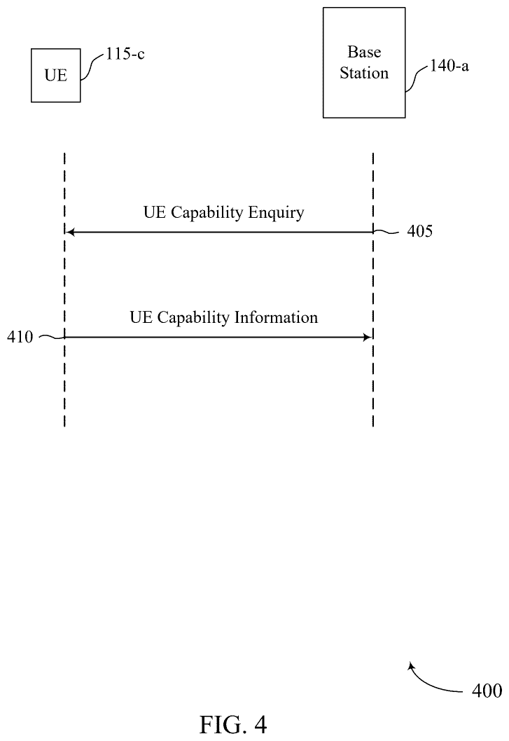

FIG. 4 shows an example of a process flow 400 that supports AI-enabled retransmissions in accordance with one or more aspects of the present disclosure. The process flow 400 may implement aspects of the wireless communications system 100 as described with reference to FIG. 1. Additionally, or alternatively, the process flow 400 may implement or be implemented by aspects of the network architecture 200 as described herein with reference to FIG. 2. The process flow 400 may include a UE 115-c and a base station 140-a, which may be examples of UEs 115 and base stations 140 as described herein. In the following description of the process flow 400, the operations between the UE 115-c and the base station 140-a may be transmitted in a different order than the example order shown, or the operations performed by the UE 115-c and the base station 140-a may be performed in different orders or at different times. Some operations may also be omitted from the process flow 400, and other operations may be added to the process flow 400.

In the example of FIG. 4, the UE 115-c may support providing an indication to the base station 140-a of one or more learning models for AI-enabled retransmission and/or AI-enabled discard, including one or more features for AI-enabled retransmission and/or AI-enabled discard, supported by the UE 115-c. At 405, the base station 140-a may transmit, and the UE 115-c may receive, a request message (e.g., a UE capability enquiry). The UE 115-c may determine, in response to the UE capability enquiry, a set of one or more UE capabilities for AI-enabled retransmission and/or AI-enabled discard. For example, the UE 115-c may determine whether the UE 115-c supports AI/ML functionality, including one or more learning models (e.g., AI/ML models) or one or more features associated with the one or more learning models for AI-enabled retransmission and/or AI-enabled discard.

At 410, the UE 115-c may transmit, and the base station 140-a may receive, a response messages (e.g., UE capability information), in response to the request message. The UE capability information may include a set of one or more features supported by the UE 115-c for AI-enabled retransmission and/or AI-enabled discard. In some examples, the UE capability information may include a set of one or more identifiers associated with the one or more learning models for AI-enabled retransmission and/or AI-enabled discard, supported by the UE 115-c. Additionally, or alternatively, the UE capability information may include at least one field (e.g., information element (IE), flag, or the like) that indicates whether a corresponding learning model is loaded (e.g., initialized, stored, cached, or the like) at the UE 115-c. Additionally, or alternatively, the UE capability information may include a set of one or more identifiers associated with one or more learning model structures for AI-enabled retransmission and/or AI-enabled discard, or a set of one or more parameters for one or more features associated with the one or more learning model structures for AI-enabled retransmission and/or AI-enabled discard.

Accordingly, the UE 115-c may be configured to support exchange of UE capability information associated with one or more learning models for AI-enabled retransmission and/or AI-enabled discard.

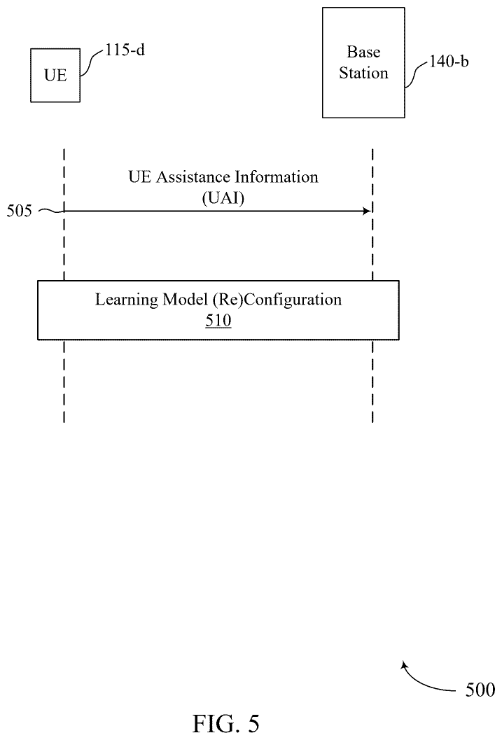

FIG. 5 shows an example of a process flow 500 that supports AI-enabled retransmissions in accordance with one or more aspects of the present disclosure. The process flow 500 may implement aspects of the wireless communications system 100 as described with reference to FIG. 1. Additionally, or alternatively, the process flow 500 may implement or be implemented by aspects of the network architecture 200 as described herein with reference to FIG. 2. The process flow 500 may include a UE 115-d and a base station 140-b, which may be examples of UEs 115 and base stations 140 as described herein. In the following description of the process flow 500, the operations between the UE 115-d and the base station 140-b may be transmitted in a different order than the example order shown, or the operations performed by the UE 115-d and the base station 140-b may be performed in different orders or at different times. Some operations may also be omitted from the process flow 500, and other operations may be added to the process flow 500.

In the example of FIG. 5, the UE 115-d may support providing UE assistance information (UAI) to the base station 140-b. More specifically, the UE 115-d may support transmitting, to the base station 140-b, UAI for managing one or more learning models for AI-enabled retransmission and/or AI-enabled discard. At 505, the UE 115-d may transmit, and the base station 140-b may receive, UAI that may indicate one or more restrictions (also referred to as restricted UE capabilities) associated with the one or more learning models for AI-enabled retransmission and/or AI-enabled discard. For example, the restricted UE capabilities may include a set of one or more learning models, a set of one or more identifiers associated with the set of one or more learning models, or both. In some examples, the restricted UE capabilities may exclude the set of one or more identifiers. In some examples, the UE 115-d may indicate a request to adjust (e.g., reduce, decrease, increase) a concurrency of the one or more learning models. For example, the UE 115-d may indicate a threshold number of concurrency (e.g., “maxAIMLconcurrency-Preference”) associated with the one or more learning models for AI-enabled retransmission and/or AI-enabled discard.

The UE 115-d may generate and transmit the UAI to the base station 140-b based at least in part on a condition (e.g., an event). One or more examples of a condition may include, but is not limited to, a battery level of the UE 115-d satisfying a battery level threshold, a processor usage level of one or more processors of the UE 115-d satisfying a processor usage level threshold, or a heat level of one or more processors of the UE 115-d satisfying a heat level threshold. For example, the UE 115-d may transmit the UAI to the base station 140-b to manage (e.g., deactivate, activate) one or more learning models for AI-enabled retransmission and/or AI-enabled discard at the UE 115-d based at least in part on one or more of the battery level of the UE 115-d satisfying the battery level threshold, the processor usage level of the one or more processors of the UE 115-d satisfying the processor usage level threshold, or the heat level of the one or more processors of the UE 115-d satisfying the heat level threshold.

Additionally, or alternatively, in some examples, the UAI may include a request for a set of one or more configurations associated with one or more learning models for AI-enabled retransmission and/or AI-enabled discard. In some examples, the UE 115-d may request the base station 140-b for the set of one or more configurations associated with the one or more learning models for AI-enabled retransmission and/or AI-enabled discard based at least in part on a change in an environment of the UE 115-d. In some other examples, the UE 115-d may request the base station 140-b for the set of one or more configurations associated with the one or more learning models for AI-enabled retransmission and/or AI-enabled discard based at least in part on a change in a state of the UE 115-d (e.g., a change between one or more of an idle state, an inactive state, or a connected state).

In other examples, the UE 115-d may request the base station 140-b for the set of one or more configurations associated with the one or more learning models for AI-enabled retransmission and/or AI-enabled discard based at least in part on a session establishment associated with a network slice. For example, the UE 115-d may establish a session (e.g., a PDU session) associated with the network slice, and request the base station 140-b for the set of one or more configurations associated with the one or more learning models for AI-enabled retransmission and/or AI-enabled discard. In some other examples, the UE 115-d may request the base station 140-b for the set of one or more configurations associated with the one or more learning models for AI-enabled retransmission and/or AI-enabled discard based at least in part on a change in a geographic coverage area of the UE 115-d. For example, the UE 115-d may enter a new geographic coverage area of a cell, public land mobile network (PLMN), and request the base station 140-b for the set of one or more configurations associated with the one or more learning models for AI-enabled retransmission and/or AI-enabled discard.

At least one configuration of the set of one or more configurations associated with provisioning of network data as input for one or more learning models (e.g., AI/ML models). In some examples, the at least one configuration may indicate at least one identifier associated with at least one learning model supporting the network data as input to the least one learning model. In some examples, the UE 115-d may request (e.g., on-demand) for the network data from the base station 140-b via the UAI, for example, based at least in part on the set of one or more configurations associated with provisioning of network data as input for one or more learning models (e.g., AI/ML models).

At 510, one or more of the UE 115-d or the base station 140-b may configure or reconfigure at least one learning model for AI-enabled retransmission and/or AI-enabled discard. For example, the base station 140-b may select at least one learning model for AI-enabled retransmission and/or AI-enabled discard to deactivate at the UE 115-d, based at least in part on the UAI, and transmit control signaling (e.g., RRC, MAC-CE, DCI) for deactivating the at least one learning model for AI-enabled retransmission and/or AI-enabled discard. For example, the base station 140-b may determine and select which learning model to deactivate at the UE 115-d based at least in part on the UAI, and transmit the control signaling (e.g., RRC, MAC-CE, DCI) that indicates for the UE 115-d to deactivate the at least one learning model for AI-enabled retransmission and/or AI-enabled discard. Additionally, or alternatively, the base station 140-b may determine and select which learning model to configure or reconfigure and activate at the UE 115-d based at least in part on the UAI. For example, the base station 140-b may determine and select which learning model to activate at the UE 115-d based at least in part on the UAI, and transmit control signaling (e.g., RRC, MAC-CE, DCI) that indicates for the UE 115-d to activate the at least one learning model for AI-enabled retransmission and/or AI-enabled discard.

Accordingly, the UE 115-d may be configured to support exchange of UAI for managing AI-enabled retransmission and/or AI-enabled discard.

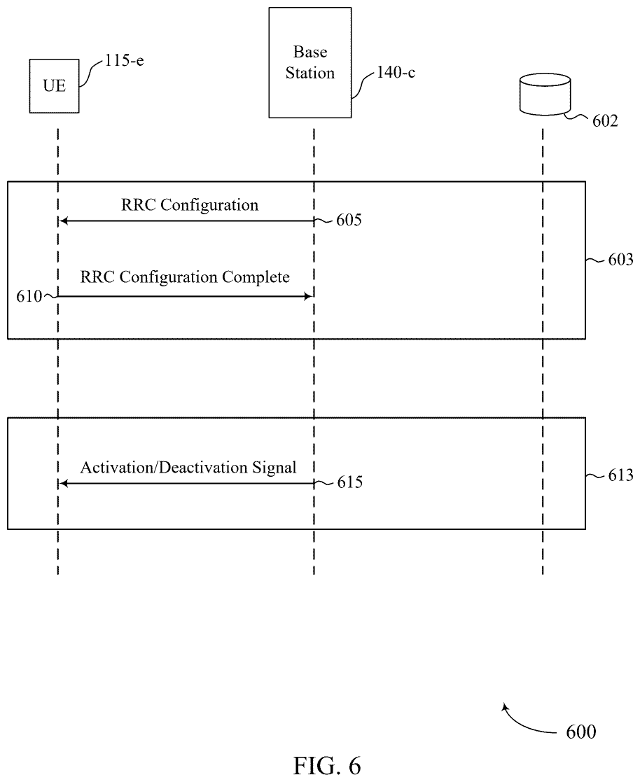

FIG. 6 shows an example of a process flow 600 that supports AI-enabled retransmissions in accordance with one or more aspects of the present disclosure. The process flow 600 may implement aspects of the wireless communications system 100 as described with reference to FIG. 1. Additionally, or alternatively, the process flow 600 may implement or be implemented by aspects of the network architecture 200 as described herein with reference to FIG. 2. The process flow 600 may include a UE 115-e and a base station 140-c, which may be respective examples of UEs 115 and base stations 140 as described herein. Additionally, the process flow 600 may include a repository 602 (e.g., a database) storing one or more learning models for AI-enabled retransmission and/or AI-enabled discard. In the following description of the process flow 600, the operations between the UE 115-e, the base station 140-c, and the repository 602 may be transmitted in a different order than the example order shown, or the operations performed by the UE 115-e, the base station 140-c, and the repository 602 may be performed in different orders or at different times. Some operations may also be omitted from the process flow 600, and other operations may be added to the process flow 600.

In the example of FIG. 6, one or more of the UE 115-e or the base station 140-c may support performing a procedure 603 (e.g., a model configuration procedure), which may include an exchange of a set of one or more configurations (or a set of one or more parameters) associated with one or more learning models for AI-enabled retransmission and/or AI-enabled discard. The set of one or more configurations (or the set of one or more parameters) associated with the one or more learning models for AI-enabled retransmission and/or AI-enabled discard may be stored at the repository 602 (e.g., a database, or the like), which the base station 140-c may obtain from the repository 602.

At 605, the base station 140-c may transmit, and the UE 115-e may receive, an RRC configuration message, which may include one or more sets of one or more configurations (or one or more sets of one or more parameters) associated with one or more learning models for AI-enabled retransmission and/or AI-enabled discard. The base station 140-c may transmit, and the UE 115-e may receive, the RRC configuration message during the procedure 603, which may be an RRC configuration procedure. In some examples, the UE 115-e may configure one or more learning models for AI-enabled retransmission and/or AI-enabled discard via a layer 3 (L3) of the UE 115-c and based at least in part on the one or more sets of one or more configurations (or the one or more sets of one or more parameters) received in the RRC configuration message. At 610, the UE 115-e may transmit, and the base station 140-c may receive, an RRC configuration complete message, for example, based at least in part on the RRC configuration message. The RRC configuration complete message may indicate a completion of the procedure 603 (e.g., the RRC configuration procedure), including configuring of the one or more learning models for AI-enabled retransmission and/or AI-enabled discard.

In the example of FIG. 6, additionally, or alternatively, at least one configuration of the sets of one or more configurations may be for provisioning network data by the base station 140-c to the UE 115-e for input to one or more learning models (e.g., AI/ML models). In some examples, the at least one configuration may indicate at least one identifier associated with at least one learning model supporting the network data as input to the least one learning model. In some examples, the UE 115-c may request the base station 140-c to activate or deactivate provisioning of network data as input to the at least one learning model via a MAC-CE. In some examples, the UE 115-e may receive, and the base station 140-c may transmit, the network data via a unicast transmission and over a physical downlink channel (e.g., a physical downlink control channel (PDCCH), a physical downlink shared channel (PDSCH)). In some other examples, the UE 115-e may receive, and the base station 140-c may transmit, the network data via a MAC-CE or an RRC message. In other examples, the UE 115-e may receive, and the base station 140-c may transmit (e.g., broadcast), the network data via system information or a multicast broadcast service (MBS) transmission.

Additionally, or alternatively, at least one configuration of the sets of one or more configurations may be for provisioning, to the base station 140-c, UE data as input for one or more learning models (e.g., AI/ML models). In some examples, the at least one configuration may indicate at least one identifier associated with at least one learning model supporting the UE data as input to the least one learning model. The base station 140-c may request, from the UE 115-c, to activate or deactivate provisioning of UE data as input to the at least one learning model via a MAC-CE. In some examples, the UE 115-e may transmit, and the base station 140-c may receive, UE data via a unicast transmission and over a physical uplink channel (e.g., a physical uplink control channel (PUCCH), a physical uplink shared channel (PUSCH)). In some other examples, the UE 115-e may transmit, and the base station 140-c may receive, the UE data via a MAC-CE or an RRC message.

At 615, the base station 140-c may transmit, and the UE 115-e may receive, a signal (also referred to as an activation signal or a deactivation signal) for activating or deactivating one or more learning models for AI-enabled retransmission and/or AI-enabled discard during a procedure 613 (e.g., an activation/deactivation procedure of one or more learning models for AI-enabled retransmission and/or AI-enabled discard). In some examples, the base station 140-c may transmit, and the UE 115-e may receive via a layer 2 (L2) of the UE 115-c, the signal for activating or deactivating the one or more learning models for AI-enabled retransmission and/or AI-enabled discard. For example, the base station 140-c may transmit, and the UE 115-e may receive, a MAC-CE that activates or deactivates the one or more learning models for AI-enabled retransmission and/or AI-enabled discard. In some examples, activating or deactivating the one or more learning models for AI-enabled retransmission and/or AI-enabled discard may be based at least in part on a switching event as described herein with reference to FIGS. 3 through 5.

Accordingly, one or more of the UE 115-e or the base station 140-c may be configured to support managing AI-enabled retransmission and/or AI-enabled discard based at least in part on activating or deactivating one or more learning models for AI-enabled retransmission and/or AI-enabled discard via MAC-CE, which allows flexible management of AI-enabled retransmission and/or AI-enabled discard.

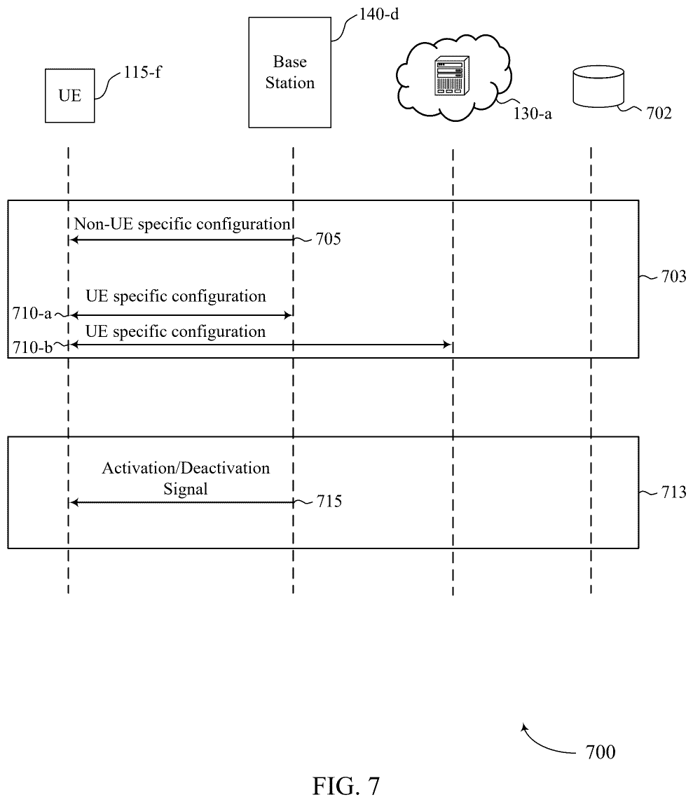

FIG. 7 shows an example of a process flow 700 that supports AI-enabled retransmissions in accordance with one or more aspects of the present disclosure. The process flow 700 may implement aspects of the wireless communications system 100 as described with reference to FIG. 1. Additionally, or alternatively, the process flow 700 may implement or be implemented by aspects of the network architecture 200 as described herein with reference to FIG. 2. The process flow 700 may include a UE 115-f, a base station 140-d, and a core network 130-a, which may be respective examples of UEs 115, base stations 140, and core networks 130 as described herein. Additionally, the process flow 700 may include a repository 702 (e.g., a database) storing one or more learning models for AI-enabled retransmission and/or AI-enabled discard. In the following description of the process flow 700, the operations between the UE 115-f, the base station 140-d, the core network 130-a, and the repository 702 may be transmitted in a different order than the example order shown, or the operations performed by the UE 115-f, the base station 140-d, the core network 130-a, and the repository 702 may be performed in different orders or at different times. Some operations may also be omitted from the process flow 700, and other operations may be added to the process flow 700.

In the example of FIG. 7, one or more of the UE 115-f, the base station 140-d, or the core network 130-a may support performing one or more procedures 703 or 713, which may include an exchange of a set of one or more configurations (or a set of one or more parameters) associated with one or more learning models for AI-enabled retransmission and/or AI-enabled discard. For example, one or more of the UE 115-f, the base station 140-d, or the core network 130-a may support performing one or more procedures, which may include an exchange of the set of one or more configurations (or the set of one or more parameters) associated with the one or more learning models for AI-enabled retransmission and/or AI-enabled discard based at least in part on a state (e.g., an idle state, an inactivate state) of the UE 115-f. In some examples, one or more of the UE 115-f, the base station 140-d, or the core network 130-a may support activating or deactivating the one or more learning models for AI-enabled retransmission and/or AI-enabled discard for inference during the state of the UE 115-f. For example, one or more of the UE 115-f, the base station 140-d, or the core network 130-a may support activating or deactivating the one or more learning models for AI-enabled retransmission and/or AI-enabled discard to perform an inference (e.g., training) of the one or more learning models for AI-enabled retransmission and/or AI-enabled discard and cell selection, cell reselection, RLF recovery, measurement operations, random access channel operations (e.g., beam selection, random access channel occasions (RO), and the like).

At 705, the base station 140-d may transmit, and the UE 115-f may receive, a set of one or more non-UE specific configurations during the procedure 703 (e.g., an RRC procedure 703, a NAS procedure 713). For example, the base station 140-d may broadcast, and the UE 115-f may receive, system information including the set of one or more non-UE specific configurations for AI-enabled retransmission and/or AI-enabled discard. The system information may include a system information block (SIB). The set of one or more non-UE specific configurations may include one or more sets of one or more parameters, which may be associated with a set of one or more learning models for AI-enabled retransmission and/or AI-enabled discard and include a set of one or more identifiers associated with the set of one or more learning models for AI-enabled retransmission and/or AI-enabled discard, etc.

Additionally, or alternatively, at 710-a, the base station 140-d may transmit, and the UE 115-f may receive, for example, via a unicast transmission, a set of one or more UE specific configurations for AI-enabled retransmission and/or AI-enabled discard. For example, the base station 140-d may transmit, and the UE 115-f may receive, an RRC message including a set of one or more UE specific configurations for AI-enabled retransmission and/or AI-enabled discard. The set of one or more UE specific configurations may include one or more sets of one or more parameters, which may be associated with a set of one or more learning models including a set of one or more identifiers associated with the set of one or more learning models for AI-enabled retransmission and/or AI-enabled discard. In some examples, the RRC message may be an RRC release message during an RRC release procedure. In some examples, at 710-b, one or more of the UE 115-f, the base station 140-d, or the core network 130-a (e.g., one or more network functions associated with the core network 130-a) may exchange one or more NAS messages associated with the set of one or more UE specific configurations.

At 715, the base station 140-d may transmit, and the UE 115-f may receive, a signal (also referred to as an activation signal or a deactivation signal) for activating or deactivating one or more learning models for AI-enabled retransmission and/or AI-enabled discard during the procedure 713 (e.g., an activation/deactivation procedure of one or more learning models for AI-enabled retransmission and/or AI-enabled discard). In some examples, the base station 140-d may transmit, and the UE 115-f may receive, the signal for activating or deactivating the one or more learning models for AI-enabled retransmission and/or AI-enabled discard. For example, the base station 140-d may transmit, and the UE 115-f may receive, a MAC-CE that activates or deactivates the one or more learning models for AI-enabled retransmission and/or AI-enabled discard and may perform an inference (e.g., training) of the one or more learning models during an idle state or an inactivate state of the UE 115-f. As such, activating or deactivating the one or more learning models for AI-enabled retransmission and/or AI-enabled discard may be based at least in part on the idle state or the inactivate state of the UE 115-f.

Accordingly, one or more of the UE 115-f, the base station 140-d, or the core network 130-a may support activating or deactivating one or more learning models for AI-enabled retransmission and/or AI-enabled discard and for inference of the one or more learning models for AI-enabled retransmission and/or AI-enabled discard during an idle state or an inactivate state of the UE 115-f.

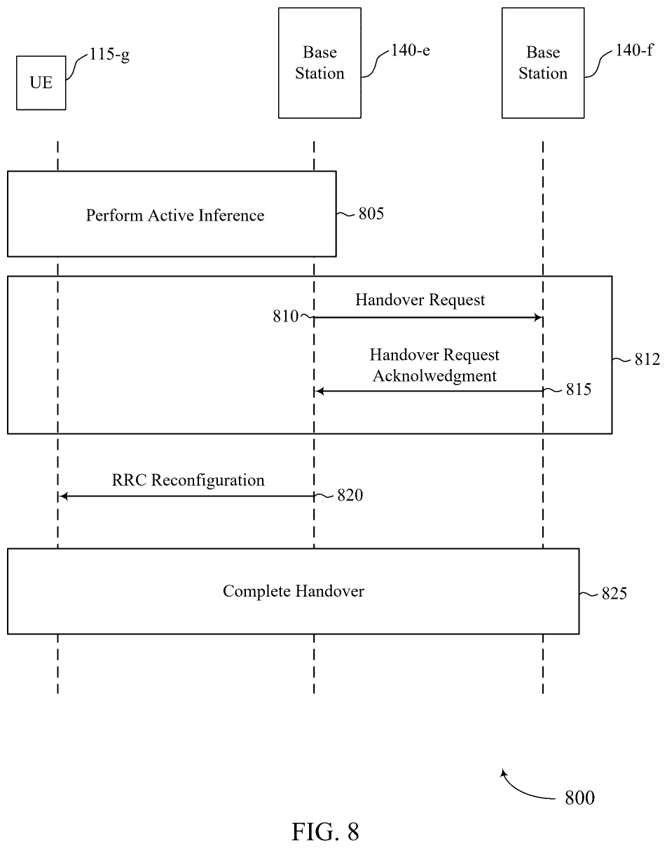

FIG. 8 shows an example of a process flow 800 that supports AI-enabled retransmissions in accordance with one or more aspects of the present disclosure. The process flow 800 may implement aspects of the wireless communications system 100 as described with reference to FIG. 1. Additionally, or alternatively, the process flow 800 may implement or be implemented by aspects of the network architecture 200 as described herein with reference to FIG. 2. The process flow 800 may include a UE 115-g, a base station 140-e, and a base station 140-f, which may be respective examples of UEs 115 and base stations 140 as described herein. In the following description of the process flow 800, the operations between the UE 115-g, the base station 140-e, and the base station 140-f may be transmitted in a different order than the example order shown, or the operations performed by the UE 115-g, the base station 140-e, and the base station 140-f may be performed in different orders or at different times. Some operations may also be omitted from the process flow 800, and other operations may be added to the process flow 800.

In the example of FIG. 8, one or more of the UE 115-g, the base station 140-e, and the base station 140-f may support managing AI-enabled retransmission and/or AI-enabled discard during a mobility (also referred to as UE mobility) of the UE 115-g. More specifically, one or more of the UE 115-g, the base station 140-e, and the base station 140-f may support managing AI/ML functionality for AI-enabled retransmission and/or AI-enabled discard associated with the UE 115-g during a handover procedure, which may include switching (e.g., transferring) a connection of the UE 115-g from the base station 140-e (also referred to as a source base station) to the base station 140-f (also referred to as a target base station) and while maintaining ongoing AI/ML functionality for AI-enabled retransmission and/or AI-enabled discard.

At 805, one or more of the UE 115-g or the base station 140-e may perform an active inference (e.g., training) of one or more learning models for AI-enabled retransmission and/or AI-enabled discard. The inference (e.g., training) of the one or more learning models for AI-enabled retransmission and/or AI-enabled discard may be based at least in part on one or more sets of one or more configurations for AI-enabled retransmission and/or AI-enabled discard, including one or more sets of one or more parameters, configured by the base station 140-c.

At 810, the base station 140-e may transmit, and the base station 140-f may receive, a handover request message, which may include context information (e.g., AI/ML context) associated with the one or more learning models for AI-enabled retransmission and/or AI-enabled discard, during a handover preparation 812. At 815, the base station 140-f may transmit, and the base station 140-e may receive, a handover request acknowledgment message, during the handover preparation 812, which may include one or more sets of one or more configurations for AI-enabled retransmission and/or AI-enabled discard, including one or more sets of one or more parameters, configured by the base station 140-f. Put another way, the base station 140-f may provide a set of one or more AI/ML configurations for the UE 115-g to apply after being handed over to the base station 140-f by the base station 140-e. In some examples, the base station 140-e may determine the sets of one or more configurations for AI-enabled retransmission and/or AI-enabled discard, including the one or more sets of one or more parameters, based at least in part on the context information (e.g., AI/ML context) received from the base station 140-f. Additionally, or alternatively, the base station 140-c may determine the sets of one or more configurations for AI-enabled retransmission and/or AI-enabled discard, including the one or more sets of one or more parameters, based at least in part on one or more of UE capabilities of the UE 115-g or network capabilities of the base station 140-f. In some examples, one or more of the UE 115-g or the base station 140-f may support partial or full AI/ML functionality (e.g., enabling of one or more features associated with at least one learning model).

At 820, the base station 140-c may transmit, and the UE 115-g may receive, an RRC reconfiguration message, which include the sets of one or more configurations for AI-enabled retransmission and/or AI-enabled discard, including the one or more sets of one or more parameters, configured by the base station 140-f. At 825, one or more of the UE 115-g, the base station 140-e, or the base station 140-f may complete handover (e.g., a handover of the UE 115-g from the base station 140-e to the base station 140-f).

Accordingly, one or more of the UE 115-g, the base station 140-e, or the base station 140-f may support managing AI-enabled retransmission and/or AI-enabled discard during a mobility of the UE 115-g.

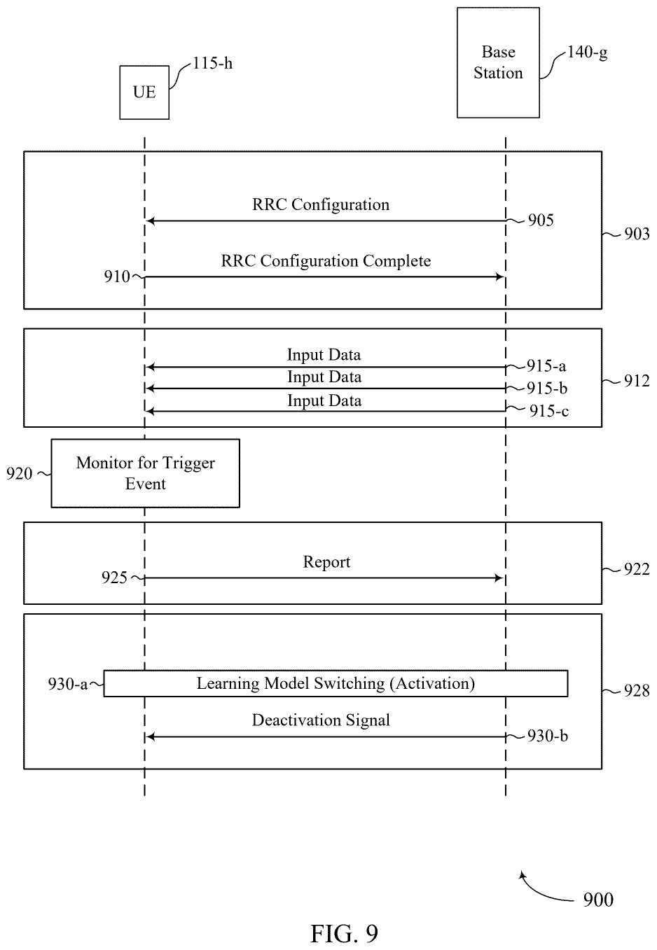

FIG. 9 shows an example of a process flow 900 that supports AI-enabled retransmissions in accordance with one or more aspects of the present disclosure. The process flow 900 may implement aspects of the wireless communications system 100 as described with reference to FIG. 1. Additionally, or alternatively, the process flow 900 may implement or be implemented by aspects of the network architecture 200 as described herein with reference to FIG. 2. The process flow 900 may include a UE 115-h and a base station 140-g, which may be respective examples of UEs 115 and base stations 140 as described herein. In the following description of the process flow 900, the operations between the UE 115-h and the base station 140-g may be transmitted in a different order than the example order shown, or the operations performed by the UE 115-h and the base station 140-g may be performed in different orders or at different times. Some operations may also be omitted from the process flow 900, and other operations may be added to the process flow 900.

In the example of FIG. 9, one or more of the UE 115-h or the base station 140-g may support activating and deactivating one or more learning models for AI-enabled retransmission and/or AI-enabled discard based at least in part on reporting of feedback associated with the one or more learning models for AI-enabled retransmission and/or AI-enabled discard by the UE 115-h.

At 905, the base station 140-g may transmit, and the UE 115-h may receive, an RRC message that includes a set of one or more RRC configurations during a procedure 903 (e.g., an RRC procedure), which may include a set of one or more parameters. In some examples, one or more parameters of the set of one or more parameters may include one or more performance KPIs or one or more system KPIs, or a combination thereof. In some other examples, one or more parameters of the set of one or more parameters may include one or more monitoring events (e.g., thresholds, conditions). In other examples, one or more parameters of the set of one or more parameters may include one or more reporting events, reporting periodicity, etc. At 910, the UE 115-h may transmit, and the base station 140-g may receive, an RRC configuration complete message during the procedure 903 (e.g., the RRC procedure).

At 915-a, the base station 140-g may transmit, and the UE 115-h may receive, input data, which may be input for one or more learning models for AI-enabled retransmission and/or AI-enabled discard at the UE 115-h. In some examples, the base station 140-g may transmit, and the UE 115-h may receive, input data via one or more unicast transmissions. For example, at 915-a, 915-b, and 915-c, the base station 140-g may transmit, and the UE 115-h may receive, input data via one or more unicast transmissions. In some other examples, the base station 140-g may broadcast, and the UE 115-h may receive, input data via one or more broadcast transmissions as described herein with reference to FIGS. 3 through 8. For example, at 915-a, 915-b, and 915-c, the base station 140-g may transmit, and the UE 115-h may receive, input data via one or more broadcast transmissions.

At 920, the UE 115-h may monitor for one or more events (e.g., threshold satisfied, conditions satisfied) associated with the one or more learning models for AI-enabled retransmission and/or AI-enabled discard. At 925, the UE 115-h may transmit, and the base station 140-g may receive, a report based at least in part on the one or more events. For example, the UE 115-h may transmit, and the base station 140-g may receive, the report during a reporting event 922. The report may indicate the one or more performance KPIs or the one or more system KPIs, or a combination thereof.

At 930-a, one or more of the UE 115-h or the base station 140-g may switch between one or more learning models for AI-enabled retransmission and/or AI-enabled discard during a switching or deactivation event 928 as described herein. For example, one or more of the UE 115-h or the base station 140-g may active at least one learning model of the one or more learning models for AI-enabled retransmission and/or AI-enabled discard based at least in part on the reported one or more performance KPIs or the reported one or more system KPIs, or a combination thereof. Additionally, or alternatively, at 930-b, one or more of the UE 115-h or the base station 140-g may activate or deactivate at least one learning model of the one or more learning models for AI-enabled retransmission and/or AI-enabled discard based at least in part on the reported one or more performance KPIs or the reported one or more system KPIs, or a combination thereof.

Accordingly, one or more of the UE 115-h or the base station 140-g may support activating and deactivating one or more learning models for AI-enabled retransmission and/or AI-enabled discard based at least in part on reported feedback associated with the one or more learning models for AI-enabled retransmission and/or AI-enabled discard by the UE 115-h.

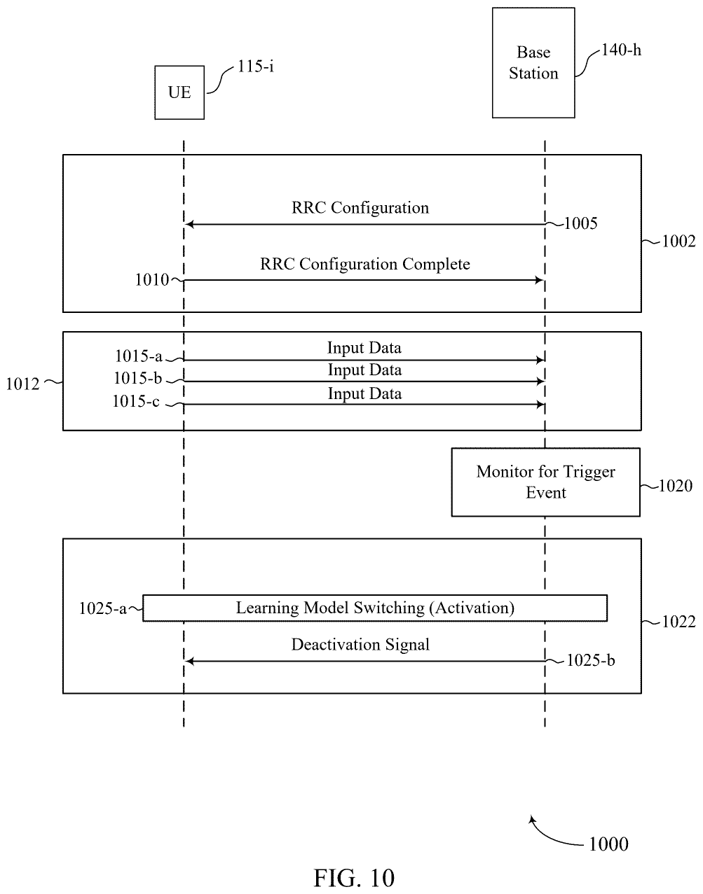

FIG. 10 shows an example of a process flow 1000 that supports AI-enabled retransmissions in accordance with one or more aspects of the present disclosure. The process flow 1000 may implement aspects of the wireless communications system 100 as described with reference to FIG. 1. Additionally, or alternatively, the process flow 1000 may implement or be implemented by aspects of the network architecture 200 as described herein with reference to FIG. 2. The process flow 1000 may include a UE 115-i and a base station 140-h, which may be respective examples of UEs 115 and base stations 140 as described herein. In the following description of the process flow 1000, the operations between the UE 115-i and the base station 140-h may be transmitted in a different order than the example order shown, or the operations performed by the UE 115-i and the base station 140-h may be performed in different orders or at different times. Some operations may also be omitted from the process flow 1000, and other operations may be added to the process flow 1000.

In the example of FIG. 10, one or more of the UE 115-i or the base station 140-h may support activating and deactivating one or more learning models for AI-enabled retransmission and/or AI-enabled discard based at least in part on monitoring by the base station 140-h of the one or more learning models for AI-enabled retransmission and/or AI-enabled discard.

At 1005, the base station 140-h may transmit, and the UE 115-i may receive, an RRC message that includes set of one or more RRC configurations during a procedure 1002 (e.g., an RRC procedure), which may include a set of one or more parameters. In some examples, one or more parameters of the set of one or more parameters may include one or more performance KPIs or one or more system KPIs, or a combination thereof. At 1010, the UE 115-i may transmit, and the base station 140-h may receive, an RRC configuration complete message during the procedure 1002 (e.g., the RRC procedure).

At 1015-a, the base station 140-h may receive, and the UE 115-i may transmit, input data, which may be input for one or more learning models for AI-enabled retransmission and/or AI-enabled discard at the base station 140-h. In some examples, the base station 140-h may receive, and the UE 115-i may transmit, input data via one or more unicast transmissions. For example, at 1015-a, 1015-b, and 1015-c, the base station 140-h may receive, and the UE 115-i may transmit, input data via one or more unicast transmissions. At 1020, the base station 140-h may monitor for one or more events (e.g., threshold satisfied, conditions satisfied) associated with the one or more learning models for AI-enabled retransmission and/or AI-enabled discard at the base station 140-h.

At 1025-a, one or more of the UE 115-i or the base station 140-h may switch between one or more learning models for AI-enabled retransmission and/or AI-enabled discard based at least in part on the one or more events and during a switching or deactivation event 1022 as described herein. For example, one or more of the UE 115-i or the base station 140-h may active at least one learning model of the one or more learning models for AI-enabled retransmission and/or AI-enabled discard based at least in part on the one or more events as described herein. Additionally, or alternatively, at 1025-b, one or more of the UE 115-i or the base station 140-h may deactivate at least one learning model of the one or more learning models for AI-enabled retransmission and/or AI-enabled discard based at least in part on the one or more events as described herein.

Accordingly, one or more of the UE 115-i or the base station 140-h may support activating and deactivating one or more learning models for AI-enabled retransmission and/or AI-enabled discard based at least in part on monitoring by the base station 140-h of the one or more learning models for AI-enabled retransmission and/or AI-enabled discard.

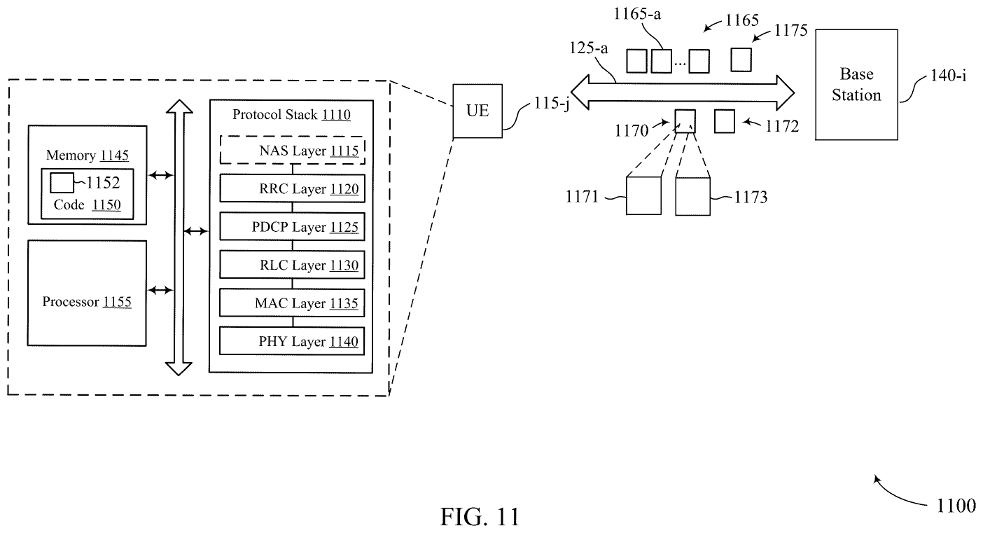

FIG. 11 shows an example of a wireless communications system 1100 that supports AI-enabled retransmissions in accordance with one or more aspects of the present disclosure. In some examples, the wireless communications system 1100 may implement or be implemented by aspects of the wireless communications system 100 as described herein with reference to FIG. 1. Additionally, or alternatively, the wireless communications system 1100 may implement or be implemented by aspects of the network architecture 200 as described herein with reference to FIG. 2. For example, the wireless communications system 1100 may include a UE 115-j and a base station 140-i, which may be an example of UEs 115 and base stations 140 as described herein with reference to FIG. 1. The wireless communications system 1100 may support 5G or radio access technologies beyond 5G.

One or more of the UE 115-j and the base station 140-i may perform wireless communication (e.g., one or more of receiving, obtaining, transmitting, or outputting one or more of control information or data) via a communication link 125-a, which may be examples of communications links 125 as described herein with reference to FIG. 1. In the example of FIG. 11, the UE 115-j may be equipped (e.g., configured) with at least one protocol stack 1110 to support one or more of receiving, obtaining, transmitting, or outputting one or more of control information or data. The at least one protocol stack 1110 may include one or more protocol layers, which may be ordered in a hierarchical architecture. In some examples, the at least one protocol stack 1110 may be associated with one or more of a control plane (and may be referred to as a control plane protocol stack) or a user plane (and may be referred to as a user plane protocol stack). The at least one protocol stack 1110 may include one or more of a NAS layer 1115 (also referred to as a NAS entity), an RRC layer 1120 (also referred to as an RLC entity), a PDCP layer 1125 (also referred to as a PDCP entity), an RLC layer 1130 (also referred to as an RLC entity), a MAC layer 1135 (also referred to as a MAC entity), or a PHY layer 1140 (also referred to as a PHY entity).

The NAS layer 1115 may be capable of, configured to, or operable to support mobility, authentication, and bearer management for the UE 115-j served by the base station 140-i. The RRC layer 1120 may be capable of, configured to, or operable to support establishment, configuration, and maintenance of a connection between the UE 115-j and the base station 140-i supporting radio bearers for user plane data. Additionally, the RRC layer 1120 may be capable of, configured to, or operable to support establishment, configuration, and maintenance of a connection between a network entity 105 or a core network 130 supporting radio bearers for user plane data as described herein with reference to FIG. 1. The PDCP layer 1125 may be capable of, configured to, or operable to support header compression, in-sequence delivery, ciphering and integrity protection, transfer of user plane and control plane data, removal of duplicates. Additionally, or alternatively, PDCP layer 1125 may be capable of, configured to, or operable to support routing the split barriers.

The RLC layer 1130 may be capable of, configured to, or operable to support transfer of upper layer PDUs according one or more modes, including: AM, UN, and TM. The RLC layer 1130 may perform error correction through ARQ, concatenation, segmentation, and reassembly of RLC SDUs, re-segmentation of RLC data PDUs, reordering of RLC data PDUs, duplicate detection, RLC re-establishment and protocol error detection and recovery. The RLC layer 1130 of the UE 115-j may receive RLC SDU from and/or transmit to upper protocol layers (e.g., the PDCP layer 1125) of the at least one protocol stack 1110 of the UE 115-j, and transmit and/or receive RLC PDU to and/or from a peer RLC entity, for example, of the base station 140-i via lower layers (e.g., the PHY layer 1140) of the at least one protocol stack 1110 of the UE 115-j.

The MAC layer 1135 may be capable of, configured to, or operable to support priority handling and multiplexing of logical channels into transport channels. Additionally, the MAC layer 1135 may be capable of, configured to, or operable to support error detection techniques, error correction techniques, or both to support retransmissions to improve link efficiency. The PHY layer 1140 may be capable of, configured to, or operable to support mapping transport channels to physical channels. Additionally, the PHY layer 1140 may be capable of, configured to, or operable to support coding/decoding, modulation/demodulation, multiantenna mapping, etc.

Additionally, the UE 115-j may be equipped with memory 1145 and processor 1155. One or more of the at least one protocol stack 1110, the memory 1145, or the processor 1155 may be in electronic communication or otherwise coupled (e.g., operatively, communicatively, functionally, electronically, electrically) via one or more buses (or interfaces). The memory 1145 may store computer-readable, computer-executable, or processor-executable code, such as code 1150. The processor 1155 may include one or more intelligent hardware devices (e.g., one or more general-purpose processors, one or more DSPs, one or more central processing units (CPUs), one or more graphics processing units (GPUs), one or more neural processing units (NPUs)), or any combination thereof).

One or more protocol layers of the protocol stack 1110 of the UE 115-j may support HARQ operations (e.g., HARQ feedback) for increasing a likelihood that a set of one or more PDUs 1165 (e.g., RLC SDUs, RLC PDUs, MAC PDUs) is received and/or transmitted via the communication link 125-a. For example, one or more of the RLC layer 1130, the MAC layer 1135, or the PHY layer 1140 may support HARQ operations for increasing a likelihood that the set of one or more PDUs 1165 (e.g., RLC SDUs, RLC PDUs, MAC PDUs) is received and/or transmitted via the communication link 125-a. In some cases, the UE 115-j may detect a success or a failure of HARQ feedback based on a set of one or more HARQ events. After processing (e.g., analyzing) the set of one or more HARQ events, the UE 115-j may predict a success or a failure of a future HARQ feedback with confidence greater than or equal to a threshold value (e.g., greater than or equal to 95%).

One or more of the RLC layer 1130, the MAC layer 1135, or the PHY layer 1140 may support retransmission of one or more PDUs of the set of one or more PDUs 1165. In some cases, retransmission of one or more PDUs of the set of one or more PDUs 1165, for example, by the RLC layer 1130 of the UE 115-j may result in high latency. In some cases, the UE 115-j may refrain from transmitting a subsequent PDU of the set of one or more PDUs 1165 until the UE 115-j receive HARQ feedback from the base station 140-i for the previous transmitted PDU of the set of one or more PDUs 1165. In some other cases, the UE 115-j may be capable of, configured to, or operable to transmit multiple PDUs of the set of one or more PDUs 1165, where each PDU of the transmitted multiple PDUs correspond to a separate HARQ process (e.g., HARQ feedback). As such, each HARQ process may have one PDU pending an ACK or a NACK.

In some cases, the UE 115-j may be capable of, configured to, or operable to support asynchronous HARQ, in which the UE 115-j may initiate a HARQ retransmission at any time. While asynchronous HARQ offers flexibility and responsiveness, in some cases, the asynchronous HARQ retransmissions may result in increased overhead and resource usage. By way of example, the UE 115-j may have to allocate memory (e.g., resources) for one or more PDUs of the set of one or more PDUs 1165 (e.g., or one or more transport blocks (TBs) of a set of one or more TBs), which may have a high likelihood to be undelivered (e.g., not successfully transmitted and/or received). When the UE 115-j infers HARQ failure with a high probability, the UE 115-j may be prohibited (e.g., prevented, refrained) from performing retransmission, and may have to wait for a status PDU from the base station 140-i. This may lead to high latency, putting strain on the memory 1145 of the UE 115-j. For example, the strain on the memory 1145 of the UE 115-j may be due to excessive buffer allocation for the set of one or more PDUs 1165 awaiting ACK and/or NACK. Additionally, or alternatively, the UE 115-j may experience an increased end-to-end latency due to slow retransmissions, even for latency-sensitive applications.

In the example of FIG. 11, the UE 115-j may be capable of, configured to, or operable to support a model 1152 (e.g., an AI/ML model) for AI-enabled retransmission and/or AI-enabled discard. The UE 115-j may additionally, or alternatively, manage a buffer (e.g., memory 1145 or other memory) of the UE 115-j in accordance with the model 1152. For example, the UE 115-j may be capable of, configured to, or operable to support an AI/ML model to manage a buffer of the UE 115-j based on one or more HARQ events. The UE 115-j may also support early retransmission of one or more PDUs of a set of one or more PDUs 1165 or discard of the one or more PDUs of the set of one or more PDUs 1165. The UE 115-j may support the early retransmission or early discard in accordance with the model 1152 and based on one or more sets of one or more parameters.

In some cases, the UE 115-j may be capable of, configured to, or operable to generate a MAC PDU by multiplexing RLC PDUs. The UE 115-j may transmit, and the base station 140-i may receive, the generated MAC PDU in HARQ based on information received via a downlink control information (DCI) or via configured grants. For example, the UE 115-j may transmit, and the base station 140-i may receive, a scheduling request (SR) and in response, the base station 140-i may transmit, and the UE 115-j may receive, a DCI that includes a grant for transmitting the generated MAC PDU to the base station 140-i. In some cases, the UE 115-j may receive HARQ feedback instructing (e.g., indicating to) the UE 115-j to retransmit the MAC PDU. In some other cases, the UE 115-j may receive HARQ feedback instructing (e.g., indicating to) the UE 115-j to use a new HARQ identifier for the retransmission. In other cases, the UE 115-j may receive HARQ feedback instructing (e.g., indicating to) the UE 115-j to transmit or retransmit using a different HARQ identifier. The UE 115-j may retain the retransmitted MAC PDU, awaiting ACK/NACK feedback via a status PDU. In some cases, if the UE 115-j receives an ACK, the UE 115-j may clear the corresponding RLC PDU from memory of the UE 115-j. In some other cases, if the UE 115-j receives a NACK, the UE 115-j may initiate retransmission.

The UE 115-j may be capable of, configured to, or operable to detect a set of one or more HARQ events to determine (e.g., predict, estimate) a result of a transmission associated with the RLC layer 1130 of the UE 115-j. In some examples, if the UE 115-j determines (e.g., predicts, estimates) an ACK with high probability (e.g., greater than or equal to a threshold value), the UE 115-j may proactively clear a corresponding PDU of the set of one or more PDUs 1165 from a buffer (e.g., memory 1145) of the UE 115-j, which may be more applicable for RLC UM. In some examples, if the UE 115-j determines (e.g., predicts, estimates) a NACK with high probability (e.g., greater than or equal to a threshold value), the UE 115-j may proactively retransmit the corresponding PDU of the set of one or more PDUs 1165, thereby reducing latency and clearing the buffer (e.g., memory 1145) of the UE 115-j. These operations (e.g., actions) may be applicable to RLC UM and/or RLC AM.

In the example of FIG. 11, the base station 140-i may transmit, and the UE 115-j may receive, a configuration 1170 including a first set of one or more parameters 1171 for HARQ associated with the RLC layer 1130 of the UE 115-j. The processor 1155 of the UE 115-j may be configured to execute computer-readable instructions stored in the memory 1145 to cause the UE 115-j to perform various functions. The code 1150 may include instructions (e.g., based at least in part on the configuration 1170) that, when executed by the at least one processor 1160 of the UE 115-j, causes the UE 115-j (e.g., one or more protocol layers of the at least one protocol stack 1110) to perform various functions (e.g., actions) described herein. The code 1150 may include the model 1152 (e.g., an AI/ML model). The code 1150 may include instructions that, when executed by the at least one processor 1160 of the UE 115-j, causes the UE 115-j (e.g., including the RLC layer 1130 of the UE 115-j) to perform one or more operations based on at least one HARQ feedback 1172 and in accordance with the first set of one or more parameters 1171 for HARQ. For example, the base station 140-i may transmit, and the UE 115-j may receive the at least one HARQ feedback 1172 associated with at least one PDU 1165-a of the set of one or more PDUs 1165. As such, the one or more operations may include a discard of at least one PDU 1165-a or a retransmission of the at least one PDU 1165-a based on the received at least one HARQ feedback 1172. In some examples, the first set of one or more parameters 1171 may include an input to the model 1152. A second set of one or more parameters 1173 may be an output of the model 1152. As such, the one or more operations may be performed by the UE 115-j (e.g., including the RLC layer 1130 of the UE 115-j) based on the output of the model 1152.

In some cases, the base station 140-i may configure whether the first set of one or more parameters 1171 are configured (e.g., allowed, enabled) and for which logical channels (LCHs), RLC entities, quality-of-service (QOS) flows, etc. In some cases, the base station 140-i may configure whether early retransmissions counts for detecting a radio link failure (RLF). The first set of one or more parameters 1171 for HARQ may include at least one first parameter (e.g., minHARQTxBeforeRetransmission) that indicates a first threshold quantity of HARQ retransmissions. The first threshold quantity of retransmissions is to be satisfied before an early retransmission of a corresponding PDU (e.g., at least one PDU 1165-a) of the set of one or more PDUs 1165. As such, the at least one first parameter may indicate a minimum amount of HARQ retransmissions before the UE 115-j may invoke a proactive retransmission via the RLC layer 1130 of the UE 115-j. The first set of one or more parameters 1171 for HARQ may include at least one second parameter (e.g., maxHARQTxBeforeRetransmission) that indicates a second threshold quantity of HARQ retransmissions. The second threshold quantity of retransmissions is to be satisfied before the early retransmission of a corresponding PDU (e.g., at least one PDU 1165-a) of the set of one or more PDUs 1165 and in response to an absence of the at least one HARQ feedback 1172 for the corresponding PDU (e.g., at least one PDU 1165-a). As such, the at least one second parameter may indicate a threshold (e.g., maximum) amount of HARQ retransmissions before the UE 115-j may invoke a proactive retransmission via the RLC layer 1130 of the UE 115-j, if no ACK is received.

The first set of one or more parameters 1171 for HARQ may include at least one third parameter (e.g., minHARQTimeBeforeRetransmission) that indicates a first threshold duration. The first threshold duration is to be satisfied after a first HARQ retransmission before the early retransmission of the corresponding PDU (e.g., at least one PDU 1165-a). As such, the at least one third parameter may indicate a threshold (e.g., minimum) time after a first HARQ transmission before the UE 115-j may invoke a proactive retransmission via the RLC layer 1130 of the UE 115-j. The first set of one or more parameters 1171 for HARQ may include at least one fourth parameter that indicates a second threshold duration. The second threshold duration is to be satisfied after the first HARQ retransmission before the early retransmission of the corresponding PDU (e.g., at least one PDU 1165-a) and in response to the absence of the at least one HARQ feedback 1172 for the corresponding PDU (e.g., at least one PDU 1165-a). As such, the at least one fourth parameter may indicate a threshold (e.g., maximum) time after the first HARQ transmission before the UE 115-j may invoke a proactive retransmission via the RLC layer 1130 of the UE 115-j, if no ACK is received.

The first set of one or more parameters 1171 for HARQ associated with the RLC layer 1130 of the UE 115-j may include at least one fifth parameter (e.g., ProactiveRetxCarrier) that indicates a set of one or more carriers that support the early retransmission of the corresponding PDU (e.g., at least one PDU 1165-a). As such, the at least one fifth parameter may indicate one or more carriers where the UE 115-a is allowed to perform proactive retransmission via the RLC layer 1130 of the UE 115-j. This can also indicate one or more rules such that the UE 115-j may retransmit on a different carrier. The first set of one or more parameters 1171 for HARQ may include at least one sixth parameter (e.g., ProactiveRetxPaddingOnly) that enables padding. As such, the corresponding PDU (e.g., at least one PDU 1165-a) for the early retransmission may be padded. The at least one sixth parameter may indicate padding for grants with excess size (e.g., above a threshold value).

The first set of one or more parameters 1171 for HARQ may include at least one seventh parameter (e.g., ProactiveRetxMax) that indicates a threshold quantity of retransmissions of the set of one or more PDUs 1165 within a time window. As such, the at least one seventh parameter may indicate a boundary or threshold on how many PDUs the UE 115-j may proactively retransmit over a certain time window. The first set of one or more parameters 1171 for HARQ may include at least one eighth parameter (e.g., ProactiveRetxMaxTime) that indicates the time window. As such, the at least one eighth parameter may indicate time window over which the proactive retransmissions are counted and compared against the threshold quantity of retransmissions of the set of one or more PDUs 1165 (e.g., ProactiveRetxMax).

The first set of one or more parameters 1171 for HARQ may include at least one ninth parameter (e.g., AIML_Allowed) that indicates whether the model 1152 for HARQ is enabled or disabled. As such, the at least one ninth parameter may indicate whether AI/ML behavior is allowed. The first set of one or more parameters 1171 for HARQ may include at least one tenth parameter (e.g., QoSFlowsAllowed) that indicates a traffic flow identifier (e.g., QoS flow identifiers) for early retransmission of one or more PDUs of the set of one or more PDUs 1165. As such, the at least one tenth parameter may indicate which QoS flows the UE 115-a is allowed to perform early RLC retransmission or discard.

In the example of FIG. 11, the configuration 1170 may include the second set of one or more parameters 1173 for HARQ associated with the RLC layer 1130 of the UE 115-j. For example, the base station 140-i may configure performance KPIs. The UE 115-j may adjust the model 1152 to ensure it satisfies the performance KPIs. The second set of one or more parameters 1173 for HARQ may include at least one first parameter (e.g., RedundantRetransmissionsAllowed) that indicates a threshold quantity of retransmissions for the set of one or more PDUs 1165. As such, the at least one first parameter may indicate allowed errors of the model 1152 causing redundant retransmissions in an evaluation time window. The second set of one or more parameters 1173 for HARQ may include at least one second parameter (e.g., RedundantRetransmissionAllowedTime) that indicates a retransmission window associated with the threshold quantity of retransmissions for the set of one or more PDUs 1165. As such, the at least one second parameter may indicate a time window over which the errors are counted for retransmission.

The second set of one or more parameters 1173 for HARQ may include at least one third parameter (e.g., RLCLatency) that indicates a latency to tune the model 1152. As such, the at least one third parameter may indicate a KPI related to the latency the UE 115-j tries to achieve when tuning the model 1152. The second set of one or more parameters for HARQ may include at least one fourth parameter (e.g., EarlyDiscardAllowed) that indicates whether discarding of one or more PDUs of the set of one or more PDUs 1165 is allowed in accordance with the model 1152. As such, the at least one fourth parameter may indicate whether discarding RLC PDUs early is allowed based on prediction of feedback (e.g., also applicable to RLC UM).

The second set of one or more parameters 1173 for HARQ may include at least one fifth parameter (e.g., EarlyDiscardAllowedCount) that indicates a threshold quantity of discards for the set of one or more PDUs 1165. As such, the at least one fifth parameter may indicate allowed model errors causing early discard of RLC PDUs in UM or AM in an evaluation time window. The second set of one or more parameters 1173 for HARQ may include at least one sixth parameter (e.g., EarlyDiscardAllowedTime) that indicates a discard window associated with the threshold quantity of discards for the set of one or more PDUs 1165. As such, the at least one sixth parameter may indicate a time window over which the errors are counted for early discard.

In some cases, the UE 115-j may be configured by the base station 140-i to execute early retransmission of one or more PDUs of the set of one or more PDUs 1165 when a HARQ failure is predicted by the model 1152 with high probability (e.g., greater than or equal to a threshold value). This behavior may result in redundant HARQ transmissions, for example, the UE 115-j may transfer one or more PDUs of the set of one or more PDUs 1165 to a new HARQ buffer while an old HARQ succeeds. To address this redundancy, the UE 115-j may indicate to the base station 140-i that a transmission of one or more PDUs of the set of one or more PDUs 1165 includes a proactive retransmission of the one or more PDUs of the set of one or more PDUs 1165.

The UE 115-j may retransmit the at least one PDU 1165-a based on at least the one HARQ feedback 1172 and in accordance with the first set of one or more parameters 1171. The at least one PDU 1165-a may be an RLC SDU, an RLC PDU, or a MAC PDU. In some examples, the UE 115-j may indicate a retransmission (e.g., a full or partial proactive retransmission) of the at least one PDU 1165-a via an RLC header of the at least one PDU 1165-a. For example, an RLC header of a PDU may indicate a proactive retransmission of an RLC SDU or an RLC PDU. In some other examples, the UE 115-j may indicate a retransmission (e.g., a full or partial proactive retransmission) of the at least one PDU 1165-a via a MAC header and/or a MAC-CE. For example, a MAC header and/or a MAC-CE may indicate a retransmission of a MAC PDU. In other examples, the UE 115-j may indicate a retransmission (e.g., a full or partial proactive retransmission) of the at least one PDU 1165-a via a UCI. For example, a UCI may indicate a retransmission of a MAC PDU. Additionally, or alternatively, a UCI header may indicate that a MAC PDU is a retransmission of another MAC PDU.

The base station 140-i may combine PDUs of the set of one or more PDUs 1165 and perform HARQ combining. The PDUs (e.g., RLC PDUs, RLC SDUs, MAC PDUs) may be handled as a new transmission, for example, after a quantity of HARQ failures satisfies a threshold quantity of HARQ failures. By way of example, an initial MAC PDU may be associated with a first HARQ identifier (e.g., HARQ ID 0) and retransmission of MAC PDU may be associated with a second HARQ identifier (e.g., HARQ ID 1). A UCI may indicate that the retransmission of the MAC PDU associated with the second HARQ identifier (e.g., HARQ ID 1) may be a proactive retransmission. In some examples, the UE 115-j may query the model 1152 to predict a redundancy version for the retransmission. The UE 115-j may select the redundancy version and retransmit the MAC PDU based on the selected redundancy version. The retransmission of the MAC PDU may be performed with a predicted best redundancy version. Accordingly, the base station 140-j may combine HARQ transmissions across HARQ identifiers for fast decoding.

The UE 115-j may obtain the second set of one or more parameters 1173 for HARQ associated with the RLC layer 1130 of the UE 115-j. The one or more operations performed by the UE 115-j (e.g., including the RLC layer 1130 of the UE 115-j) may be based on the second set of one or more parameters 1173. The UE 115-j may be capable of, configured to, or operable to perform AI-enabled retransmission and/or AI-enabled discard and/or AI-enabled discards based on one or more predictions of ACK and/or NACK. In some examples, the UE 115-j, the one or more predictions of ACK and/or NACK may be based on the second set of one or more parameters 1173 for HARQ associated with the RLC layer 1130 of the UE 115-j, which may be based on memory requirements and power saving requirements associated with the UE 115-j. As such, the one or more operations may be performed by the UE 115-j (e.g., including the RLC layer 1130 of the UE 115-j) based on memory requirements and power saving requirements associated with the UE 115-j.

In some other examples, the one or more predictions of ACK and/or NACK may be based on the second set of one or more parameters 1173 for HARQ associated with the RLC layer 1130 of the UE 115-j, which may be based on a set of one or more HARQ events. As such, the one or more operations may be performed by the UE 115-j (e.g., including the RLC layer 1130 of the UE 115-j) based on the set of one or more HARQ events. In other examples, the one or more predictions of ACK and/or NACK may be based on the second set of one or more parameters 1173 for HARQ associated with the RLC layer 1130 of the UE 115-j, which may include a packet delay budget. As such, the one or more operations may be performed by the UE 115-j (e.g., including the RLC layer 1130 of the UE 115-j) based on that the packet delay budget satisfies or predicted to satisfy a threshold value. Put another way, the AI-enabled retransmission and/or AI-enabled discard and/or AI-enabled discards behavior may be a function of the packet delay budget associated with the at least one PDU 1165-a (e.g., RLC SDU, RLC PDU) and the UE 115-j prediction that the at least one PDU 1165-a may violate latency bounds. That is, the UE 115-j can be more aggressive in early retransmissions if the UE 115-j predicts a packet is going to expire.

The UE 115-j may generate a report associated with the model 1152 for the HARQ associated with the RLC layer 1130 of the UE 115-j. The report may include a set of one or more logs associated with processing of one or more PDUs of the set of one or more PDUs 1165 in accordance with the model 1152. The reporting of the set of one or more logs associated with processing of one or more PDUs of the set of one or more PDUs 1165 in accordance with the model 1152 may facilitate improvements to the model 1152. For example, by reporting of the set of one or more logs associated with processing of one or more PDUs of the set of one or more PDUs 1165 in accordance with the model 1152, the model 1152 may be capable of or configured to predict with high confidence (e.g., greater than or equal to a threshold confidence) success or failure of PDUs (e.g., RLC PDUs, RLC SDUs, MAC PDUs) or HARQ based on HARQ events and other PHY events.

In some other examples, by reporting of the set of one or more logs associated with processing of one or more PDUs of the set of one or more PDUs 1165 in accordance with the model 1152, the model 1152 may be capable of or configured to predict with high confidence (e.g., greater than or equal to a threshold confidence) one or more of a carrier, a grant, and a HARQ identifier for retransmission of one or more PDUs of the set of one or more PDUs 1165. In other examples, by reporting of the set of one or more logs associated with processing of one or more PDUs of the set of one or more PDUs 1165 in accordance with the model 1152, the model 1152 may be capable of or configured to estimate with high confidence (e.g., greater than or equal to a threshold confidence) a probability of HARQ retransmission scheduling for a MAC PDU. In some other examples, by reporting of the set of one or more logs associated with processing of one or more PDUs of the set of one or more PDUs 1165 in accordance with the model 1152, the model 1152 may be capable of or configured to predict (e.g., determine) a redundancy version in cases of HARQ combining to increase the probability of successful decoding.

The at least one log of the set of one or more logs indicates one or more of the first set of one or more parameters 1171 for HARQ associated with the RLC layer 1130 of the UE 115-j, the second set of one or more parameters 1173 for HARQ associated with the RLC layer 1130 of the UE 115-j, timing information associated with one or more dropped PDUs of the set of one or PDUs 1165 or one or more retransmitted PDUs of the set of one or PDUs 1165 (e.g., all predictions of RLC/HARQ success and/or failure with a timestamp and a level of confidence of the UE 115-j), or a set of one or more SNs associated with the one or more dropped PDUs of the set of one or PDUs 1165 or one or more retransmitted PDUs of the set of one or PDUs 1165 (i.e., SNs that were proactively retransmitted and/or dropped). In some other examples, at least one log of the set of one or more logs may indicate one or more actions related to early PDU flushing (e.g., in the event of predicted ACK) or early retransmissions (in the event of predicted NACK). In other examples, at least one log of the set of one or more logs may indicate parameters and detected events by the UE 115-j. Additionally, or alternatively, the UE 115-j may report via at least one log of the set of one or more logs observed (e.g., detected) errors and performance metric (e.g., KPI) satisfaction of the predictive behavior.

In the example of FIG. 11, one or more of the UE 115-j and the base station 140-j may maintain a set of one or more performance metrics (e.g., a set of one or more KPIs) related to a performance of the model 1152 (e.g., AI-enabled retransmission and/or AI-enabled discard, AI-enabled discards). The UE 115-j may determine a set of one or more performance metrics associated with the model 1152 for HARQ associated with the RLC layer 1130 of the UE 115-j based on the one or more operations performed. The set of one or more performance metrics may be based on a set of one or more HARQ events associated with the set of one or more PDUs 1165. For example, based on the UE 115-j detection of duplicated ACKs and/or NACK or eventual HARQ success and/or failure subsequent to a prediction of the model 1152, the UE 115-j may determine (e.g., calculate) a prediction error and ensure that the UE 115-j meets one or more performance metrics of the set of one or more performance metrics. The one or more performance metrics may be network-configured KPIs. In such instances, the UE 115-j may report errors, KPI satisfaction, or other performance metrics to the base station 140-i or other network entities as described herein with reference to FIG. 1.

The base station 140-i may receive, from the UE 115-j), one or more indications or, based on the base station 140-i, detection of arriving PDU duplicates of the set of one or more PDUs 1165. In such instances, the base station 140-i may inform the UE 115-j about statistics related to errors (e.g., via duplicate observed SN), or the base station 140-i may report semi-statically (e.g., in a STATUS control PDU) or upon detecting an error. For example, the base station 140-i may transmit, and the UE 115-j may receive, a STATUS control PDU that includes a report that indicates a set of one or more errors associated with the model 1152 for HARQ. The report may indicate one or more of a quantity of duplicate SNs of PDUs or a quantity of duplicate PDUs. As such, the STATUS control PDU can include detected duplicated SNs, or the STATUS control PDU can indicate a total count of detected duplicated PDUs. For some KPIs, such as throughput within a packet delay budget, the base station 140-i may report the set of one or more performance metrics, such as a percentage of packets (e.g., RLC SDU, RLC PDU) that arrive after packet delay budget expiry. As such, the UE 115-j may determine prediction error based on one or more of the set of one or more performance metrics or the reported set of one or more errors associated with the model 1152 for HARQ by the base station 140-i.

The UE 115-j may transmit, and the base station 140-i may receive a report 1175 including capability information that indicates whether the UE 115-j supports the model 1152 for HARQ. The capability information may be based on a performance metric associated with the model 1152. In some examples, the configuration 1170 may be received based on the capability information that indicates whether the UE 115-j supports the model 1152. As such, the capability information may be indicative of whether the UE 115-j supports early retransmissions or early discard, along with information regarding model prediction accuracy or supported KPIs. Accordingly, the UE 115-j may indicate its capability to support AI native early RLC retransmissions or accurate HARQ success prediction. Additionally, the UE 115-j may report model accuracy, indicating a performance accuracy in terms of model error. Additionally, or alternatively, the UE 115-j may report supported KPIs in terms of throughput, parameterized with packet data buffer, channel quality indicator (CQI), a number of carriers, etc.

The UE 115-j may be capable of, configured to, or operable to support a fallback behavior in case one or more performance metrics of a set of one or more performance metrics (e.g., KPIs) cannot be maintained (e.g., the UE 115-j is performing excessive redundant retransmissions). In some examples, UE 115-j may be capable of, configured to, or operable to fallback to legacy non-model behavior (e.g., non-AI/ML behavior) for a certain backoff period. In some other examples, the UE 115-j may be capable of, configured to, or operable transmit an indication of the disabled model 1152 and at least one performance metric of the set of one or more performance metrics, where the at least one performance metric is to be satisfied before disabling the model 1152. As such, the UE 115-j may transmit a KPI violation report to the base station 140-i or other network entity (e.g., an AI/ML server). In other examples, the UE 115-j may be capable of, configured to, or operable disable the model 1152 (e.g., AI/ML model) for the RLC layer 1130 of the UE 115-j and/or logical channel (LCH).

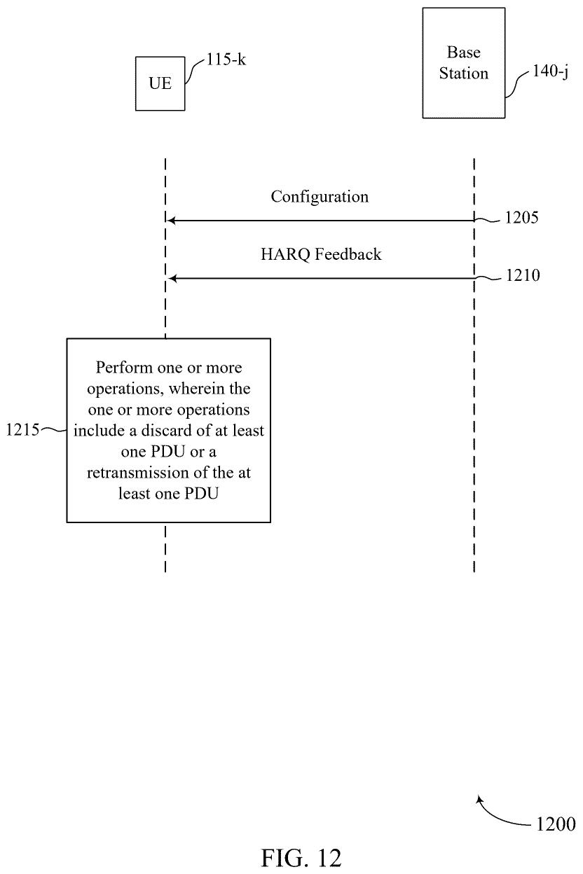

FIG. 12 shows an example of a process flow 1200 that supports AI-enabled retransmissions in accordance with one or more aspects of the present disclosure. The process flow 1200 may implement aspects of the wireless communications system 100 as described with reference to FIG. 1. Additionally, or alternatively, the process flow 1200 may implement or be implemented by aspects of the network architecture 200 as described herein with reference to FIG. 2. The process flow 1200 may include a UE 115-k and a base station 140-j, which may be examples of UEs 115 and base stations 140 as described herein. In the following description of the process flow 1200, the operations between the UE 115-k and the base station 140-j may be transmitted in a different order than the example order shown, or the operations performed by the UE 115-k and the base station 140-j may be performed in different orders or at different times. Some operations may also be omitted from the process flow 1200, and other operations may be added to the process flow 1200.

In the example of FIG. 12, The UE 115-k may be capable of, configured to, or operable to support processing (e.g., executing) a model (e.g., an AI/ML model) on one or more HARQ events to perform early discard or early retransmission (e.g., of one or more PDUs) based at least in part on the one or more HARQ events.

At 1205, the base station 140-j may transmit, and the UE 115-k may receive, control signaling that indicates a configuration including a first set of one or more parameters for HARQ associated with an RLC entity of the UE 115-k. In some examples, the control signaling may be an RRC message and the configuration may be an RRC configuration.

At 1210, the base station 140-j may transmit, and the UE 115-k may receive, at least one HARQ feedback. For example, the base station 140-j may transmit, and the UE 115-k may receive, at least one HARQ feedback for at least one PDU of a set of one or more PDUs associated with the RLC entity of the UE 115-k.

At 1215, the UE 115-k may perform one or more operations, wherein the one or more operations include a discard of at least one PDU or a retransmission of the at least one PDU. For example, the UE 115-k may perform the one or more operations based at least in part on the at least one HARQ feedback and in accordance with the first set of one or more parameters for HARQ.

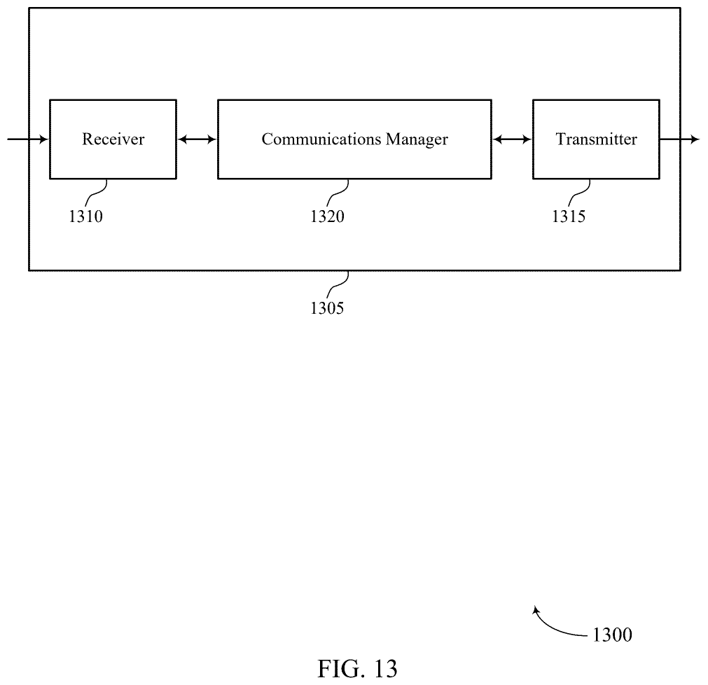

FIG. 13 shows a block diagram 1300 of a device 1305 that supports AI-enabled retransmissions in accordance with one or more aspects of the present disclosure. The device 1305 may be an example of aspects of a UE 115 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to AI-enabled retransmission and/or AI-enabled discard). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to AI-enabled retransmission and/or AI-enabled discard). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations or components thereof may be examples of means for performing various aspects of AI-enabled retransmission and/or AI-enabled discard as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for receiving control signaling that indicates a configuration including a first set of one or more parameters for HARQ associated with a RLC entity of the device 1305. The communications manager 1320 is capable of, configured to, or operable to support a means for receiving at least one HARQ feedback for at least one PDU of a set of one or more PDUs associated with the RLC entity of the device 1305. The communications manager 1320 is capable of, configured to, or operable to support a means for performing one or more operations based on the at least one HARQ feedback and in accordance with the first set of one or more parameters for HARQ, where the one or more operations include a discard of the at least one PDU or a retransmission of the at least one PDU.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced processing and reduced power consumption.

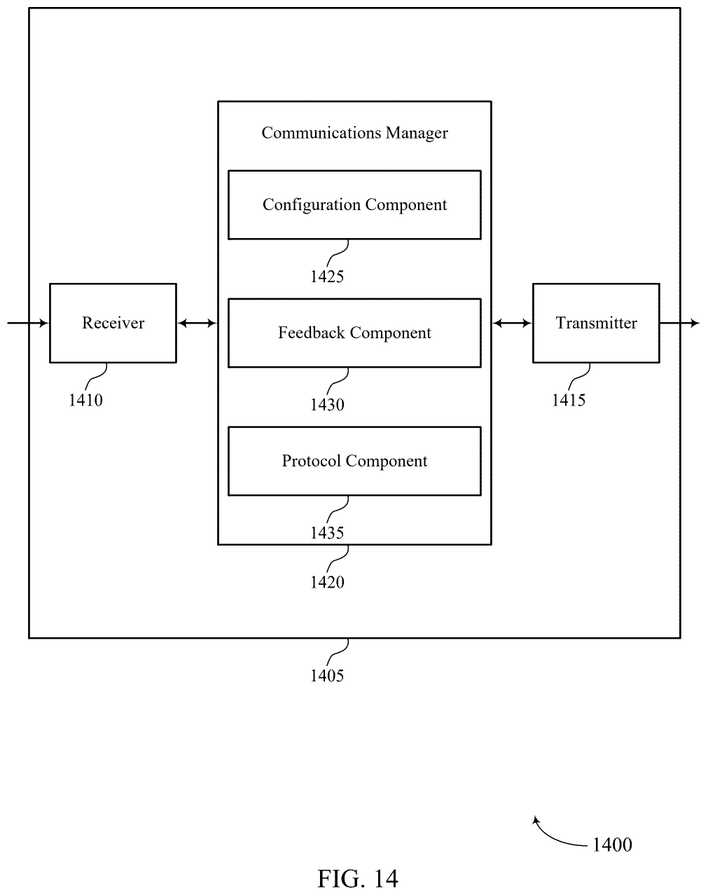

FIG. 14 shows a block diagram 1400 of a device 1405 that supports AI-enabled retransmissions in accordance with one or more aspects of the present disclosure. The device 1405 may be an example of aspects of a device 1305 or a UE 115 as described herein. The device 1405 may include a receiver 1410, a transmitter 1415, and a communications manager 1420. The device 1405, or one of more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for receiving information such as packets, user data, control information, or any combination thereof associated with various information channels (e.g., control channels, data channels, information channels related to AI-enabled retransmission and/or AI-enabled discard). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to AI-enabled retransmission and/or AI-enabled discard). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of AI-enabled retransmission and/or AI-enabled discard as described herein. For example, the communications manager 1420 may include a configuration component 1425, a feedback component 1430, a protocol component 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The configuration component 1425 is capable of, configured to, or operable to support a means for receiving control signaling that indicates a configuration including a first set of one or more parameters for HARQ associated with a RLC entity of the device 1405. The feedback component 1430 is capable of, configured to, or operable to support a means for receiving at least one HARQ feedback for at least one PDU of a set of one or more PDUs associated with the RLC entity of the device 1405. The protocol component 1435 is capable of, configured to, or operable to support a means for performing one or more operations based on the at least one HARQ feedback and in accordance with the first set of one or more parameters for HARQ, where the one or more operations include a discard of the at least one PDU or a retransmission of the at least one PDU.

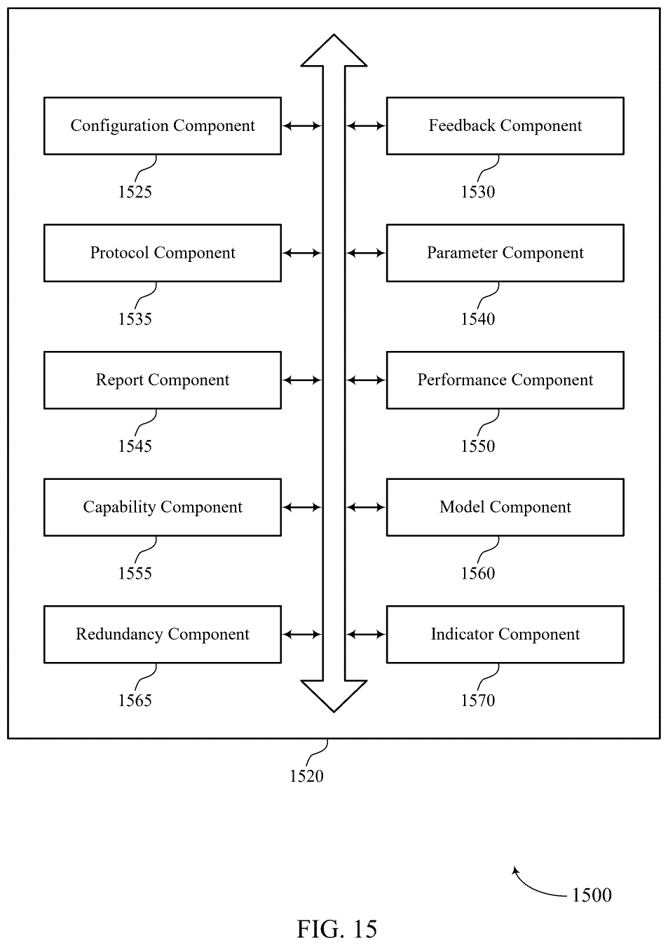

FIG. 15 shows a block diagram 1500 of a communications manager 1520 that supports AI-enabled retransmissions in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of AI-enabled retransmission and/or AI-enabled discard as described herein. For example, the communications manager 1520 may include a configuration component 1525, a feedback component 1530, a protocol component 1535, a parameter component 1540, a report component 1545, a performance component 1550, a capability component 1555, a model component 1560, a redundancy component 1565, an indicator component 1570, or any combination thereof. Each of these components, or components or subcomponents thereof (e.g., one or more processors, one or more memories), may communicate, directly or indirectly, with one another (e.g., via one or more buses).

The communications manager 1520 may support wireless communications in accordance with examples as disclosed herein. The configuration component 1525 is capable of, configured to, or operable to support a means for receiving control signaling that indicates a configuration including a first set of one or more parameters for HARQ associated with a RLC entity of the wireless device. The feedback component 1530 is capable of, configured to, or operable to support a means for receiving at least one HARQ feedback for at least one PDU of a set of one or more PDUs associated with the RLC entity of the wireless device. The protocol component 1535 is capable of, configured to, or operable to support a means for performing one or more operations based on the at least one HARQ feedback and in accordance with the first set of one or more parameters for HARQ, where the one or more operations include a discard of the at least one PDU or a retransmission of the at least one PDU.

In some examples, the first set of one or more parameters includes an input to a model for the HARQ associated with the RLC entity of the wireless device. In some examples, a second set of one or more parameters includes an output of the model. In some examples, the one or more operations are performed further based on the output of the model.

In some examples, the protocol component 1535 is capable of, configured to, or operable to support a means for retransmitting the at least one PDU based on the at least one HARQ feedback and in accordance with the first set of one or more parameters. In some examples, the at least one PDU includes one or more of a RLC service data unit, a RLC PDU, or a medium access control PDU.

In some examples, a RLC header of the at least one PDU indicates a retransmission of one or more of the RLC service data unit or the RLC PDU.

In some examples, a MAC header of a MAC-CE indicates a retransmission of the MAC PDU. In some examples, a UCI indicates the retransmission of the at least one PDU. In some examples, a UCI header or UCI indicates a retransmission of the at least one PDU.

In some examples, the redundancy component 1565 is capable of, configured to, or operable to support a means for selecting a redundancy version of a set of redundancy versions for the retransmission of the at least one PDU. In some examples, the redundancy component 1565 is capable of, configured to, or operable to support a means for retransmitting the at least one PDU based on the redundancy version.

In some examples, the parameter component 1540 is capable of, configured to, or operable to support a means for obtaining a second set of one or more parameters for HARQ associated with the RLC entity of the wireless device. In some examples, the one or more operations are performed further based on the second set of one or more parameters.

In some examples, at least one parameter of the second set of one or more parameters includes a packet delay budget. In some examples, the one or more operations are performed further based on that the packet delay budget satisfies or predicted to satisfy a threshold value.

In some examples, the report component 1545 is capable of, configured to, or operable to support a means for generating a report associated with a model for the HARQ associated with the RLC entity of the wireless device, where the report includes a set of one or more logs associated with processing of one or more PDUs of the set of one or more PDUs in accordance with the model. In some examples, the report component 1545 is capable of, configured to, or operable to support a means for transmitting, to a network entity, the report associated with the model.

In some examples, at least one log of the set of one or more logs indicates one or more of the first set of one or more parameters for HARQ associated with the RLC entity of the wireless device, a second set of one or more parameters for HARQ associated with the RLC entity of the wireless device, timing information associated with one or more dropped PDUs of the set of one or more PDUs or one or more retransmitted PDUs of the set of one or more PDUs, or a set of one or more sequence numbers associated with the one or more dropped PDUs of the set of one or more PDUs or one or more retransmitted PDUs of the set of one or more PDUs.

In some examples, the performance component 1550 is capable of, configured to, or operable to support a means for determining a set of one or more performance metrics associated with a model for HARQ associated with a RLC entity of the wireless device based on the one or more operations performed, where the set of one or more performance metrics is based on a set of one or more HARQ events associated with the set of one or more PDUs. In some examples, the performance component 1550 is capable of, configured to, or operable to support a means for receiving, from a network entity, a status control PDU that includes a report that indicates a set of one or more errors associated with the model for HARQ, where the report indicates one or more of a quantity of duplicate sequence numbers of RLC PDU or a quantity of duplicate PDUs. In some examples, the performance component 1550 is capable of, configured to, or operable to support a means for determining a prediction error based on one or more of the set of one or more performance metrics or the reported set of one or more errors associated with the model for HARQ by the network entity.

In some examples, the capability component 1555 is capable of, configured to, or operable to support a means for transmitting, to a network entity, a report including capability information that indicates whether the wireless device supports a model for HARQ associated with the RLC entity of the wireless device, where the capability information is based on a performance metric associated with the model. In some examples, the control signaling is received based on the capability information that indicates whether the wireless device supports the model.

In some examples, the first set of one or more parameters includes at least one first parameter that indicates a first threshold quantity of HARQ retransmissions, where the first threshold quantity of retransmissions is to be satisfied before an early retransmission of the at least one PDU. In some examples, the first set of one or more parameters includes at least one second parameter that indicates a second threshold quantity of HARQ retransmissions, where the second threshold quantity of retransmissions is to be satisfied before the early retransmission of the at least one PDU and in response to an absence of the at least one HARQ feedback for the at least one PDU. In some examples, the first set of one or more parameters includes at least one third parameter that indicates a first threshold duration, where the first threshold duration is to be satisfied after a first HARQ retransmission before the early retransmission of the at least one PDU. In some examples, the first set of one or more parameters includes at least one fourth parameter that indicates a second threshold duration, where the second threshold duration is to be satisfied after the first HARQ retransmission before the early retransmission of the at least one PDU and in response to the absence of the at least one HARQ feedback for the at least one PDU. In some examples, the first set of one or more parameters includes at least one fifth parameter that indicates a set of one or more carriers that support the early retransmission of the at least one PDU. In some examples, the first set of one or more parameters includes at least one sixth parameter that enables padding, where the at least one PDU of the early retransmission of the at least one PDU is padded. In some examples, the first set of one or more parameters includes at least one seventh parameter that indicates a threshold quantity of retransmissions of the set of one or more PDUs within a time window. In some examples, the first set of one or more parameters includes at least one eighth parameter that indicates the time window. In some examples, the first set of one or more parameters includes at least one ninth parameter that indicates whether a model for HARQ is enabled or disabled. In some examples, the first set of one or more parameters includes at least one tenth parameter that indicates a traffic flow identifier for early retransmission of one or more PDUs of the set of one or more PDUs.

In some examples, the control signaling includes a second set of one or more parameters for HARQ associated with the RLC entity of the wireless device.

In some examples, the second set of one or more parameters includes at least one first parameter that indicates a threshold quantity of retransmissions for the set of one or more PDUs. In some examples, the second set of one or more parameters includes at least one second parameter that indicates a retransmission window associated with the threshold quantity of retransmissions for the set of one or more PDUs. In some examples, the second set of one or more parameters includes at least one third parameter that indicates a latency to tune a model for HARQ associated with the RLC entity of the wireless device. In some examples, the second set of one or more parameters includes at least one fourth parameter that indicates whether discarding of one or more PDUs of the set of one or more PDUs is allowed in accordance with the model for HARQ associated with the RLC entity of the wireless device. In some examples, the second set of one or more parameters includes at least one fifth parameter that indicates a threshold quantity of discards for the set of one or more PDUs. In some examples, the second set of one or more parameters includes at least one sixth parameter that indicates a discard window associated with the threshold quantity of discards for the set of one or more PDUs.

In some examples, the model component 1560 is capable of, configured to, or operable to support a means for disabling a model for the HARQ associated with the RLC entity of the wireless device based on at least one parameter of a second set of one or more parameters. In some examples, the one or more operations are performed further based on the disabled model.

In some examples, the indicator component 1570 is capable of, configured to, or operable to support a means for transmitting, to a network entity, an indication of the disabled model and the at least one parameter of the second set of one or more parameters, where the at least one parameter is to be satisfied before disabling the model.

In some examples, the one or more operations are performed irrespective of the disabled model.

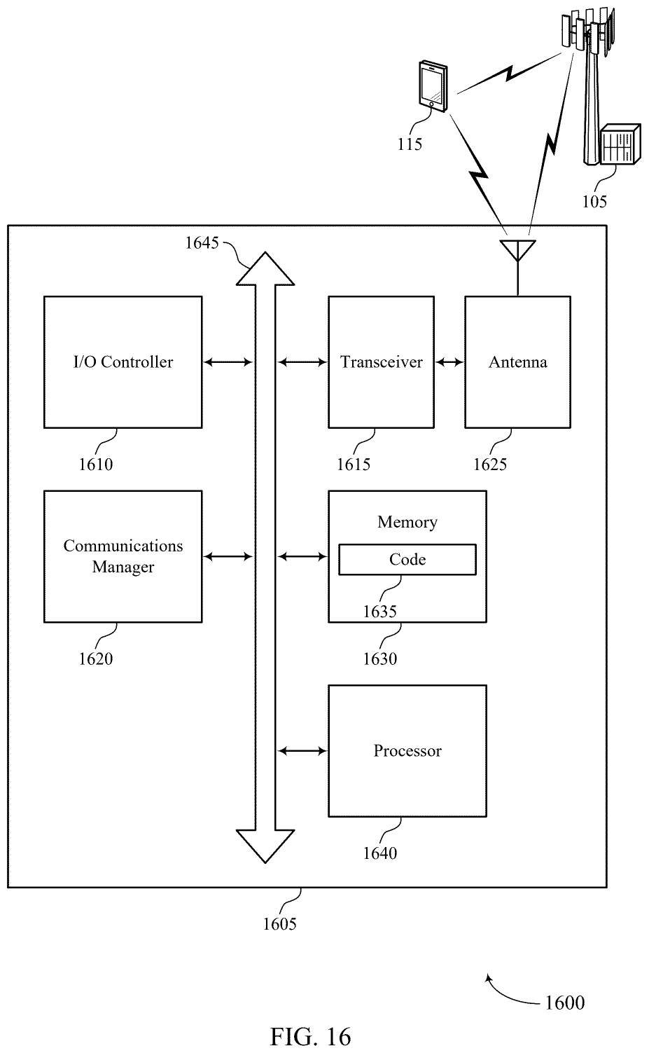

FIG. 16 shows a diagram of a system 1600 including a device 1605 that supports AI-enabled retransmissions in accordance with one or more aspects of the present disclosure. The device 1605 may be an example of or include components of a device 1305, a device 1405, or a UE 115 as described herein. The device 1605 may communicate (e.g., wirelessly) with one or more other devices (e.g., network entities 105, UEs 115, or a combination thereof). The device 1605 may include components for bi-directional voice and data communications including components for transmitting and receiving communications, such as a communications manager 1620, an input/output (I/O) controller, such as an I/O controller 1610, a transceiver 1615, one or more antennas 1625, at least one memory 1630, code 1635, and at least one processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally, or alternatively, the I/O controller 1610 may represent or interact with a modem, a keyboard, a mouse, a touchscreen, or a similar device. In some cases, the I/O controller 1610 may be implemented as part of one or more processors, such as the at least one processor 1640. In some cases, a user may interact with the device 1605 via the I/O controller 1610 or via hardware components controlled by the I/O controller 1610.

In some cases, the device 1605 may include a single antenna. However, in some other cases, the device 1605 may have more than one antenna, which may be capable of concurrently transmitting or receiving multiple wireless transmissions. The transceiver 1615 may communicate bi-directionally via the one or more antennas 1625 using wired or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The at least one memory 1630 may include random access memory (RAM) and read-only memory (ROM). The at least one memory 1630 may store computer-readable, computer-executable, or processor-executable code, such as the code 1635. The code 1635 may include instructions that, when executed by the at least one processor 1640, cause the device 1605 to perform various functions described herein. The code 1635 may be stored in a non-transitory computer-readable medium such as system memory or another type of memory. In some cases, the code 1635 may not be directly executable by the at least one processor 1640 but may cause a computer (e.g., when compiled and executed) to perform functions described herein. In some cases, the at least one memory 1630 may include, among other things, a basic I/O system (BIOS) which may control basic hardware or software operation such as the interaction with peripheral components or devices.

The at least one processor 1640 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1640 may be configured to operate a memory array using a memory controller. In some other cases, a memory controller may be integrated into the at least one processor 1640. The at least one processor 1640 may be configured to execute computer-readable instructions stored in a memory (e.g., the at least one memory 1630) to cause the device 1605 to perform various functions (e.g., functions or tasks supporting AI-enabled retransmission and/or AI-enabled discard). For example, the device 1605 or a component of the device 1605 may include at least one processor 1640 and at least one memory 1630 coupled with or to the at least one processor 1640, the at least one processor 1640 and the at least one memory 1630 configured to perform various functions described herein.

In some examples, the at least one processor 1640 may include multiple processors and the at least one memory 1630 may include multiple memories. One or more of the multiple processors may be coupled with one or more of the multiple memories, which may, individually or collectively, be configured to perform various functions described herein. In some examples, the at least one processor 1640 may be a component of a processing system, which may refer to a system (such as a series) of machines, circuitry (including, for example, one or both of processor circuitry (which may include the at least one processor 1640) and memory circuitry (which may include the at least one memory 1630)), or components, that receives or obtains inputs and processes the inputs to produce, generate, or obtain a set of outputs. The processing system may be configured to perform one or more of the functions described herein. For example, the at least one processor 1640 or a processing system including the at least one processor 1640 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code 1635 (e.g., processor-executable code) stored in the at least one memory 1630 or otherwise, to perform one or more of the functions described herein.

The communications manager 1620 may support wireless communications in accordance with examples as disclosed herein. For example, the communications manager 1620 is capable of, configured to, or operable to support a means for receiving control signaling that indicates a configuration including a first set of one or more parameters for HARQ associated with a RLC entity of the device 1605. The communications manager 1620 is capable of, configured to, or operable to support a means for receiving at least one HARQ feedback for at least one PDU of a set of one or more PDUs associated with the RLC entity of the device 1605. The communications manager 1620 is capable of, configured to, or operable to support a means for performing one or more operations based on the at least one HARQ feedback and in accordance with the first set of one or more parameters for HARQ, where the one or more operations include a discard of the at least one PDU or a retransmission of the at least one PDU.

By including or configuring the communications manager 1620 in accordance with examples as described herein, the device 1605 may support techniques for reduced power consumption.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the at least one processor 1640, the at least one memory 1630, the code 1635, or any combination thereof. For example, the code 1635 may include instructions executable by the at least one processor 1640 to cause the device 1605 to perform various aspects of AI-enabled retransmission and/or AI-enabled discard as described herein, or the at least one processor 1640 and the at least one memory 1630 may be otherwise configured to, individually or collectively, perform or support such operations.

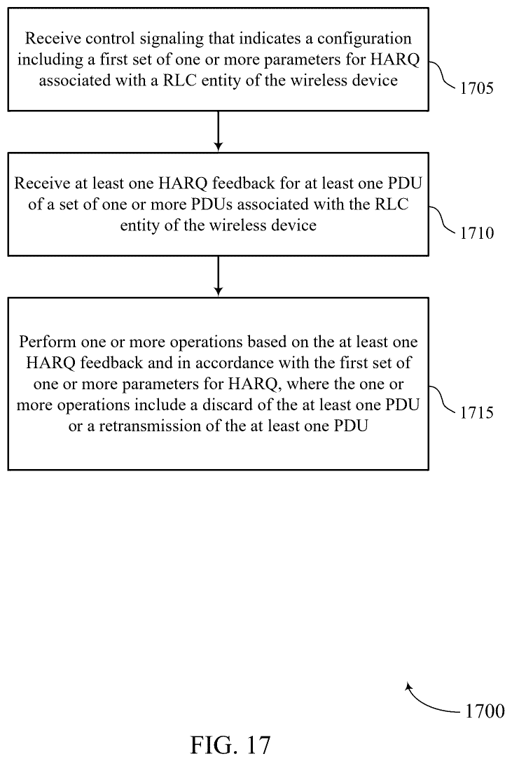

FIG. 17 shows a flowchart illustrating a method 1700 that supports AI-enabled retransmissions in accordance with one or more aspects of the present disclosure. The operations of the method 1700 may be implemented by a UE or its components as described herein. For example, the operations of the method 1700 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 1705, the method may include receiving control signaling that indicates a configuration including a first set of one or more parameters for HARQ associated with a RLC entity of the wireless device. The operations of 1705 may be performed in accordance with examples as disclosed herein. In some examples, aspects of the operations of 1705 may be performed by a configuration component 1525 as described with reference to FIG. 15.

At 1710, the method may include receiving at least one HARQ feedback for at least one PDU of a set of one or more PDUs associated with the RLC entity of the wireless device. The operations of 1710 may be performed in accordance with examples as disclosed herein. In some examples, aspects of the operations of 1710 may be performed by a feedback component 1530 as described with reference to FIG. 15.

At 1715, the method may include perform one or more operations based on the at least one HARQ feedback and in accordance with the first set of one or more parameters for HARQ, where the one or more operations include a discard of the at least one PDU or a retransmission of the at least one PDU. The operations of 1715 may be performed in accordance with examples as disclosed herein. In some examples, aspects of the operations of 1715 may be performed by a protocol component 1535 as described with reference to FIG. 15.

It should be noted that the methods described herein describe possible implementations. The operations and the steps may be rearranged or otherwise modified and other implementations are possible. Further, aspects from two or more of the methods may be combined.

The following provides an overview of aspects of the present disclosure:

Aspect 1: A method for wireless communications at a wireless device, comprising: receiving control signaling that indicates a configuration comprising a first set of one or more parameters for HARQ associated with a RLC entity of the wireless device; receiving at least one HARQ feedback for at least one PDU of a set of one or more PDUs associated with the RLC entity of the wireless device; and perform one or more operations based at least in part on the at least one HARQ feedback and in accordance with the first set of one or more parameters for HARQ, wherein the one or more operations include a discard of the at least one PDU or a retransmission of the at least one PDU.

Aspect 2: The method of aspect 1, wherein the first set of one or more parameters comprises an input to a model for the HARQ associated with the RLC entity of the wireless device, a second set of one or more parameters comprises an output of the model, and the one or more operations are performed further based at least in part on the output of the model.

Aspect 3: The method of any of aspects 1 through 2, further comprising: retransmitting the at least one PDU based at least in part on the at least one HARQ feedback and in accordance with the first set of one or more parameters, wherein the at least one PDU comprises one or more of a RLC SDU, a RLC PDU, or a MAC PDU.

Aspect 4: The method of aspect 3, wherein a RLC header of the at least one PDU indicates a retransmission of one or more of the RLC SDU or the RLC PDU.

Aspect 5: The method of any of aspects 3 through 4, wherein a MAC header of a MAC-CE indicates a retransmission of the MAC PDU, or an UCI indicates the retransmission of the at least one PDU.

Aspect 6: The method of any of aspects 3 through 5, wherein an UCI header or UCI indicates a retransmission of the at least one PDU.

Aspect 7: The method of any of aspects 3 through 6, further comprising: selecting a redundancy version of a set of redundancy versions for the retransmission of the at least one PDU; and retransmitting the at least one PDU based at least in part on the redundancy version.

Aspect 8: The method of any of aspects 1 through 7, further comprising: obtaining a second set of one or more parameters for HARQ associated with the RLC entity of the wireless device, wherein the one or more operations are performed further based at least in part on the second set of one or more parameters.

Aspect 9: The method of aspect 8, wherein at least one parameter of the second set of one or more parameters comprises a packet delay budget, and the one or more operations are performed further based at least in part on that the packet delay budget satisfies or predicted to satisfy a threshold value.

Aspect 10: The method of any of aspects 1 through 9, further comprising: generate a report associated with a model for the HARQ associated with the RLC entity of the wireless device, wherein the report comprises a set of one or more logs associated with processing of one or more PDUs of the set of one or more PDUs in accordance with the model; and transmit, to a network entity, the report associated with the model.

Aspect 11: The method of aspect 10, wherein at least one log of the set of one or more logs indicates one or more of the first set of one or more parameters for HARQ associated with the RLC entity of the wireless device, a second set of one or more parameters for HARQ associated with the RLC entity of the wireless device, timing information associated with one or more dropped PDUs of the set of one or more PDUs or one or more retransmitted PDUs of the set of one or more PDUs, or a set of one or more sequence numbers associated with the one or more dropped PDUs of the set of one or more PDUs or one or more retransmitted PDUs of the set of one or more PDUs.

Aspect 12: The method of any of aspects 1 through 11, further comprising: determining a set of one or more performance metrics associated with a model for HARQ associated with a RLC entity of the wireless device based at least in part on the one or more operations performed, wherein the set of one or more performance metrics is based at least in part on a set of one or more HARQ events associated with the set of one or more PDUs; receiving, from a network entity, a status control PDU that includes a report that indicates a set of one or more errors associated with the model for HARQ, wherein the report indicates one or more of a quantity of duplicate sequence numbers of RLC PDU or a quantity of duplicate PDUs; and determining a prediction error based at least in part on one or more of the set of one or more performance metrics or the reported set of one or more errors associated with the model for HARQ by the network entity.

Aspect 13: The method of any of aspects 1 through 12, further comprising: transmit, to a network entity, a report comprising capability information that indicates whether the wireless device supports a model for HARQ associated with the RLC entity of the wireless device, wherein the capability information is based at least in part on a performance metric associated with the model, wherein the control signaling is received based at least in part on the capability information that indicates whether the wireless device supports the model.

Aspect 14: The method of any of aspects 1 through 13, wherein the first set of one or more parameters comprises: at least one first parameter that indicates a first threshold quantity of HARQ retransmissions, wherein the first threshold quantity of retransmissions is to be satisfied before an early retransmission of the at least one PDU; at least one second parameter that indicates a second threshold quantity of HARQ retransmissions, wherein the second threshold quantity of retransmissions is to be satisfied before the early retransmission of the at least one PDU and in response to an absence of the at least one HARQ feedback for the at least one PDU; at least one third parameter that indicates a first threshold duration, wherein the first threshold duration is to be satisfied after a first HARQ retransmission before the early retransmission of the at least one PDU; at least one fourth parameter that indicates a second threshold duration, wherein the second threshold duration is to be satisfied after the first HARQ retransmission before the early retransmission of the at least one PDU and in response to the absence of the at least one HARQ feedback for the at least one PDU; at least one fifth parameter that indicates a set of one or more carriers that support the early retransmission of the at least one PDU; at least one sixth parameter that enables padding, wherein the at least one PDU of the early retransmission of the at least one PDU is padded; at least one seventh parameter that indicates a threshold quantity of retransmissions of the set of one or more PDUs within a time window; at least one eighth parameter that indicates the time window; at least one ninth parameter that indicates whether a model for HARQ is enabled or disabled; or at least one tenth parameter that indicates a traffic flow identifier for early retransmission of one or more PDUs of the set of one or more PDUs.

Aspect 15: The method of any of aspects 1 through 14, wherein the control signaling comprises a second set of one or more parameters for HARQ associated with the RLC entity of the wireless device, wherein the second set of one or more parameters comprises: at least one first parameter that indicates a threshold quantity of retransmissions for the set of one or more PDUs; at least one second parameter that indicates a retransmission window associated with the threshold quantity of retransmissions for the set of one or more PDUs; at least one third parameter that indicates a latency to tune a model for HARQ associated with the RLC entity of the wireless device; at least one fourth parameter that indicates whether discarding of one or more PDUs of the set of one or more PDUs is allowed in accordance with the model for HARQ associated with the RLC entity of the wireless device; at least one fifth parameter that indicates a threshold quantity of discards for the set of one or more PDUs; and at least one sixth parameter that indicates a discard window associated with the threshold quantity of discards for the set of one or more PDUs.

Aspect 16: The method of any of aspects 1 through 15, further comprising: disabling a model for the HARQ associated with the RLC entity of the wireless device based at least in part on at least one parameter of a second set of one or more parameters, wherein the one or more operations are performed further based at least in part on the disabled model.

Aspect 17: The method of aspect 16, further comprising: transmitting, to a network entity, an indication of the disabled model and the at least one parameter of the second set of one or more parameters, wherein the at least one parameter is to be satisfied before disabling the model.

Aspect 18: The method of any of aspects 16 through 17, wherein the one or more operations are performed irrespective of the disabled model.

Aspect 19: A wireless device for wireless communications, comprising one or more memories storing processor-executable code, and one or more processors coupled with the one or more memories and individually or collectively operable to execute the code to cause the wireless device to perform a method of any of aspects 1 through 18.

Aspect 20: A wireless device for wireless communications, comprising at least one means for performing a method of any of aspects 1 through 18.

Aspect 21: A non-transitory computer-readable medium storing code for wireless communications, the code comprising instructions executable by one or more processors to perform a method of any of aspects 1 through 18.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
receive control signaling that indicates a configuration comprising a first set of one or more parameters for hybrid automatic repeat request associated with a radio link control entity of the wireless device;
receive at least one hybrid automatic repeat request feedback for at least one protocol data unit of a set of one or more protocol data units associated with the radio link control entity of the wireless device; and
perform one or more operations based at least in part on the at least one hybrid automatic repeat request feedback and in accordance with the first set of one or more parameters for hybrid automatic repeat request, wherein the one or more operations include a discard of the at least one protocol data unit or a retransmission of the at least one protocol data unit.

2. The wireless device of claim 1, wherein the first set of one or more parameters comprises an input to a model for the hybrid automatic repeat request associated with the radio link control entity of the wireless device, wherein a second set of one or more parameters comprises an output of the model, and wherein the one or more operations are performed further based at least in part on the output of the model.

3. The wireless device of claim 1, wherein the one or more processors are individually or collectively further operable to execute the code to cause the wireless device to:
retransmit the at least one protocol data unit based at least in part on the at least one hybrid automatic repeat request feedback and in accordance with the first set of one or more parameters,
wherein the at least one protocol data unit comprise one or more of a radio link control service data unit, a radio link control protocol data unit, or a medium access control protocol data unit.

4. The wireless device of claim 3, wherein a radio link control header of the at least one protocol data unit indicates a retransmission of one or more of the radio link control service data unit or the radio link control protocol data unit.

5. The wireless device of claim 3, wherein a medium access control header of a medium access control-control element (MAC-CE) indicates a retransmission of the medium access control protocol data unit, or wherein an uplink control information indicates the retransmission of the at least one protocol data unit.

6. The wireless device of claim 3, wherein an uplink control information header or uplink control information indicates a retransmission of the at least one protocol data unit.

7. The wireless device of claim 3, wherein the one or more processors are individually or collectively further operable to execute the code to cause the wireless device to:
select a redundancy version of a set of redundancy versions for the retransmission of the at least one protocol data unit; and
retransmit the at least one protocol data unit based at least in part on the redundancy version.

8. The wireless device of claim 1, wherein the one or more processors are individually or collectively further operable to execute the code to cause the wireless device to:
obtain a second set of one or more parameters for hybrid automatic repeat request associated with the radio link control entity of the wireless device,
wherein the one or more operations be performed further based at least in part on the second set of one or more parameters.

9. The wireless device of claim 8, wherein at least one parameter of the second set of one or more parameters comprises a packet delay budget, and wherein the one or more operations are performed further based at least in part on that the packet delay budget satisfies or predicted to satisfy a threshold value.

10. The wireless device of claim 1, wherein the one or more processors are individually or collectively further operable to execute the code to cause the wireless device to:
generate a report associated with a model for the hybrid automatic repeat request associated with the radio link control entity of the wireless device, wherein the report comprises a set of one or more logs associated with processing of one or more protocol data units of the set of one or more protocol data units in accordance with the model; and
transmit, to a network entity, the report associated with the model.

11. The wireless device of claim 10, wherein at least one log of the set of one or more logs indicates one or more of the first set of one or more parameters for hybrid automatic repeat request associated with the radio link control entity of the wireless device, a second set of one or more parameters for hybrid automatic repeat request associated with the radio link control entity of the wireless device, timing information associated with one or more dropped protocol data units of the set of one or more protocol data units or one or more retransmitted protocol data units of the set of one or more protocol data units, or a set of one or more sequence numbers associated with the one or more dropped protocol data units of the set of one or more protocol data units or one or more retransmitted protocol data units of the set of one or more protocol data units.

12. The wireless device of claim 1, wherein the one or more processors are individually or collectively further operable to execute the code to cause the wireless device to:
determine a set of one or more performance metrics associated with a model for hybrid automatic repeat request associated with a radio link control entity of the wireless device based at least in part on the one or more operations performed, wherein the set of one or more performance metrics is based at least in part on a set of one or more hybrid automatic repeat request events associated with the set of one or more protocol data units;
receive, from a network entity, a status control protocol data unit that includes a report that indicates a set of one or more errors associated with the model for hybrid automatic repeat request, wherein the report indicates one or more of a quantity of duplicate sequence numbers of radio link control protocol data unit or a quantity of duplicate protocol data units; and
determine a prediction error based at least in part on one or more of the set of one or more performance metrics or the reported set of one or more errors associated with the model for hybrid automatic repeat request by the network entity.

13. The wireless device of claim 1, wherein the one or more processors are individually or collectively further operable to execute the code to cause the wireless device to:
transmit, to a network entity, a report comprising capability information that indicates whether the wireless device supports a model for hybrid automatic repeat request associated with the radio link control entity of the wireless device, wherein the capability information is based at least in part on a performance metric associated with the model,
wherein the control signaling is received based at least in part on the capability information that indicates whether the wireless device supports the model.

14. The wireless device of claim 1, wherein, to first set of one or more parameters, the one or more processors are individually or collectively operable to execute the code to cause the wireless device to:
at least one first parameter that indicate a first threshold quantity of hybrid automatic repeat request retransmissions, wherein the first threshold quantity of retransmissions is to be satisfied before an early retransmission of the at least one protocol data unit;
at least one second parameter that indicate a second threshold quantity of hybrid automatic repeat request retransmissions, wherein the second threshold quantity of retransmissions is to be satisfied before the early retransmission of the at least one protocol data unit and in response to an absence of the at least one hybrid automatic repeat request feedback for the at least one protocol data unit;
at least one third parameter that indicate a first threshold duration, wherein the first threshold duration is to be satisfied after a first hybrid automatic repeat request retransmission before the early retransmission of the at least one protocol data unit;
at least one fourth parameter that indicate a second threshold duration, wherein the second threshold duration is to be satisfied after the first hybrid automatic repeat request retransmission before the early retransmission of the at least one protocol data unit and in response to the absence of the at least one hybrid automatic repeat request feedback for the at least one protocol data unit;
at least one fifth parameter that indicate a set of one or more carriers that support the early retransmission of the at least one protocol data unit;
at least one sixth parameter that enable padding, wherein the at least one protocol data unit of the early retransmission of the at least one protocol data unit is padded;
at least one seventh parameter that indicate a threshold quantity of retransmissions of the set of one or more protocol data units within a time window;
at least one eighth parameter that indicate the time window;
at least one ninth parameter that indicate whether a model for hybrid automatic repeat request is enabled or disabled; or
at least one tenth parameter that indicate a traffic flow identifier for early retransmission of one or more protocol data units of the set of one or more protocol data units.

15. The wireless device of claim 1, wherein, to second set of one or more parameters, the one or more processors are individually or collectively operable to execute the code to cause the wireless device to:
at least one first parameter that indicate a threshold quantity of retransmissions for the set of one or more protocol data units;
at least one second parameter that indicate a retransmission window associated with the threshold quantity of retransmissions for the set of one or more protocol data units;
at least one third parameter that indicate a latency to tune a model for hybrid automatic repeat request associated with the radio link control entity of the wireless device;
at least one fourth parameter that indicate whether discarding of one or more protocol data units of the set of one or more protocol data units is allowed in accordance with the model for hybrid automatic repeat request associated with the radio link control entity of the wireless device;
at least one fifth parameter that indicate a threshold quantity of discards for the set of one or more protocol data units; and
at least one sixth parameter that indicate a discard window associated with the threshold quantity of discards for the set of one or more protocol data units.

16. The wireless device of claim 1, wherein the one or more processors are individually or collectively further operable to execute the code to cause the wireless device to:
disable a model for the hybrid automatic repeat request associated with the radio link control entity of the wireless device based at least in part on at least one parameter of a second set of one or more parameters,
wherein the one or more operations be performed further based at least in part on the disabled model.

17. The wireless device of claim 16, wherein the one or more processors are individually or collectively further operable to execute the code to cause the wireless device to:
transmit, to a network entity, an indication of the disabled model and the at least one parameter of the second set of one or more parameters, wherein the at least one parameter is to be satisfied before disabling the model.

18. The wireless device of claim 16, wherein the one or more operations are performed irrespective of the disabled model.

19. A method for wireless communications at a wireless device, comprising:
receiving control signaling that indicates a configuration comprising a first set of one or more parameters for hybrid automatic repeat request associated with a radio link control entity of the wireless device;
receiving at least one hybrid automatic repeat request feedback for at least one protocol data unit of a set of one or more protocol data units associated with the radio link control entity of the wireless device; and
performing one or more operations based at least in part on the at least one hybrid automatic repeat request feedback and in accordance with the first set of one or more parameters for hybrid automatic repeat request, wherein the one or more operations include a discard of the at least one protocol data unit or a retransmission of the at least one protocol data unit.

20. A wireless device for wireless communications, comprising:
means for receiving control signaling that indicates a configuration comprising a first set of one or more parameters for hybrid automatic repeat request associated with a radio link control entity of the wireless device;
means for receiving at least one hybrid automatic repeat request feedback for at least one protocol data unit of a set of one or more protocol data units associated with the radio link control entity of the wireless device; and
means for performing one or more operations based at least in part on the at least one hybrid automatic repeat request feedback and in accordance with the first set of one or more parameters for hybrid automatic repeat request, wherein the one or more operations include a discard of the at least one protocol data unit or a retransmission of the at least one protocol data unit.
